(19) United States
(12) Patent Application Publication
(10) Pub. No.: US 2013/0017777 A1
(43) Pub. Date: Jan. 17, 2013

(54) Wireless Network System, Method of Controlling the System, and Wireless Network Relay Device

(71) Applicant: Yoshifumi Haba, Nagoya-shi (JP)

(72) Inventor: Yoshifumi Haba, Nagoya-shi (JP)

(73) Assignee: BUFFALO INC., Nagoya-shi (JP)

(21) Appl. No.: 13/527,518

(22) Filed: Jun. 19, 2012

(30) Foreign Application Priority Data
Jul. 15, 2011 (JP) 2011-156285

(51) Int. Cl. H04W 88/04

(52) U.S. Cl. 455/11.1

(57) ABSTRACT

Wireless network system including mobile and fixed wireless access points. The access points each include a connection unit for connecting to the partner access point and enabling communications between them. The mobile access point has a download-request accepting unit, and a download-request transmitting unit that transmits an accepted download request conditional upon both the access points being connected to each other via the mobile access point's connection unit. The fixed access point has a download-request receiving unit that receives download requests when transmitted from the mobile access point via the fixed access point's connection unit, and has a file acquisition unit that in response to a thus-received download request downloads the file via the fixed access point's communications network. A file transmitting unit in the fixed access point transmits the thus-downloaded file to the mobile access point via the fixed access point's connection unit.

### BACKGROUND OF THE INVENTION

1. Technical Field

The present invention relates to techniques for downloading files via wireless network relay devices.

2. Description of the Related Art

Wireless local area network (LAN) access points (also referred to simply as “access points” hereinafter) are widely used in homes and offices for connecting wireless LAN clients (also referred to simply as “clients” hereinafter) such as personal computers (PCs) and game machines to a network. Utilized as the access points are compact, lightweight devices (also referred to as “mobile wireless network relay device” hereinafter) that excel in portability and connect to mobile telecommunications networks such as a third-generation (3G)/High Speed Packet Access (HSPA) line, instead of landline communications networks. Using the mobile wireless network relay device enables a client to connect to the Internet in locations (such as outdoors, for example) where no fixed wireless network relay device is available. (Reference is made to Japanese Unexamined Patent Application Publication No. 2005-142907.)

Mobile telecommunications networks have narrower communications bands than those of landline communications networks. Consequent problems with obtaining (i.e., downloading) files stored in a server on the Internet via a mobile wireless network relay device have been prolonged file-downloading times, substantially reducing the remaining battery capacity of the mobile wireless network relay device, and increased data-processing loads imposed on the mobile wireless network relay device by the file downloading. Consequently, when the mobile wireless network relay device handles other communications different from file downloading, there is a likelihood of degraded communication speed and similar influences on the other communications.

### BRIEF SUMMARY OF THE INVENTION

An object of the present invention is to resolve at least part of the issues discussed above.

A wireless network system involving the present invention is a wireless network system comprising a mobile wireless access point for relaying client accessing of a first communications network, and a fixed wireless access point for relaying client accessing of a second communications network. The mobile wireless access point includes: a first connection unit for connecting to the fixed wireless access point and enabling communications between the fixed and mobile wireless access points; a first download-request accepting unit for receiving from the client a download request that requests downloading of a file; a download-request transmitting unit for transmitting, when the mobile wireless access point and the fixed wireless access point are connected to each other via the first connection unit, a received download request to the fixed wireless access point via the first connection unit; a file storage unit for storing files; and a file-storage control unit for receiving, via the first connection unit, a file transmitted from the fixed wireless access point, and storing the file in the file storage unit. The fixed wireless access point includes: a second connection unit for connecting to the first connection unit of the mobile wireless access point and enabling communications between the mobile and fixed wireless access points; a download-request receiving unit for receiving, when the mobile wireless access point and the fixed wireless access point are connected to each other via the second connection unit, a transmitted download request from the mobile wireless access point via the second connection unit; a first file acquisition unit for downloading, based on a received download request, a file via the second communications network; and a file transmitting unit for transmitting, when the mobile wireless access point and the fixed wireless access point are connected to each other via the second connection unit, the downloaded file to the mobile wireless access point via the second connection unit.

With the configuration described above, a download request from a client requesting download is received in the mobile wireless access point and is transmitted to the fixed wireless access point when the mobile wireless access point and the fixed wireless access point are connected to each other. The fixed wireless access point downloads the file based on the received request requesting downloading, and sends the downloaded file to the mobile wireless access point. Thus, since the fixed wireless access point executes the file downloading, files may be downloaded while increased load on the mobile wireless access point is kept to a minimum. Further, since increased load on the mobile wireless access point may be held to a minimum, built-in resources (e.g., CPU and memory) in the device itself can be made lower-level performance components (a CPU of slower processing speed and memory of smaller capacity). Therefore, it is possible to reduce the size and production cost of the mobile wireless access point. Furthermore, the downloaded file is stored in the file storage unit disposed in the mobile wireless access point. Therefore, when the mobile wireless access point is detached from the fixed wireless access point or in a like situation, the file downloaded by the fixed wireless access point can be presented to the client from the mobile wireless access point.

In the wireless network system according to the present invention, the first file acquisition unit downloads the file via a second communications network having a wider communications band than that of the first communications network.

The configuration described above makes it possible to download a file via a second communications network having a wider communications band than that of the first communications network. It is therefore possible to shorten the period required to download the file.

In a wireless network system according to the present invention, the first download-request accepting unit receives a download request including file-specifying information for specifying a file to be downloaded. In addition, the mobile wireless access point further includes a file-specifying information storage unit for storing the file-specifying information, and a file-specifying information storage control unit for controlling storing, into the file-specifying information storage unit, of the file-specifying information that the download request contains. Further, the download-request transmitting unit transmits, to the fixed wireless access point via the first connection unit, the download request including the file-specifying information stored in the file-specifying information storage unit.

The configuration described above makes it possible to decrease the data volume of download requests sent to the fixed wireless access point from the mobile wireless access point.

In a wireless network system according to the present invention, the mobile wireless access point further includes a download start-timing acquisition unit for acquiring a download-start timing relating to a file to be downloaded, and a second file acquisition unit for downloading the file based on the received download request. Further, the download-request transmitting unit transmits, if the download-start timing is within a predetermined period, the download request to the second file acquisition unit, and transmits, if the download-start timing is not within the predetermined period, the download request to the fixed wireless access point when the mobile wireless access point and the fixed wireless access point are connected to each other via the first connection unit.

The configuration described above makes it possible to download a file corresponding to the start-timing of the downloading.

In the wireless network system according to the present invention, if the download-start timing is within a predetermined period the file-specifying information storage control unit stores no file-specifying information of the file relating to the download-start timing in the file-specifying information storage unit.

The configuration described above makes it possible to prevent double downloading of the same file by the mobile wireless access point and the fixed wireless access point.

In the wireless network system according to the present invention, the mobile wireless access point further includes a download start-timing designation user-interface provision unit for providing the client with a download start-timing designation user-interface upon accepting the download request from the client, the user interface for designating a start timing for downloading the file.

The configuration described above makes it possible to facilitate control of the start timing for downloading a file by using a user interface. Therefore, for example, when the mobile wireless access point does not process other communications or in a like situation, it is possible to download a file using a second file acquisition unit disposed in the mobile wireless access point, thereby enabling a real-time downloading of the file while preventing impact on other communications.

In the wireless network system according to the present invention, the fixed wireless access point further includes a second download request accepting unit for accepting a download request from the client. Further, the first download request accepting unit stops accepting a download request if the mobile wireless access point and the fixed wireless access point are connected to each other via the second connection unit. Further, the second download request accepting unit accepts a download request if the mobile wireless access point and the fixed wireless access point are connected to each other via the second connection unit. Further, the first file acquisition unit downloads the file based on the download request accepted by the second download request accepting unit.

The configuration described above makes it possible also to receive a download request from a client when the mobile wireless access point and the fixed wireless access point are connected to each other. Further, when the mobile wireless access point and the fixed wireless access point are connected to each other, communications with a client can be halted in the mobile wireless access point. This enables both the mobile wireless access point and the fixed wireless access point to communicate with the client, preventing occurrence of a situation where the user of the client cannot know which device to communicate with, and thus is unable to send a download request.

In the wireless network system according to the present invention, the mobile wireless access point further includes a connection determination unit for determining whether interconnection between the mobile wireless access point and the fixed wireless access point via the first connection unit is established such that the download-request transmitting unit transmits the download request to the fixed wireless access point via the first connection unit, if the connection determination unit determines that the interconnection is established.

The configuration described above makes it possible to cause the mobile wireless access point to send a download request to the fixed wireless access point only when the mobile wireless access point and the fixed wireless access point are connected to each other. It is therefore possible to minimize transmission of download requests when the mobile wireless access point and the fixed wireless access point are not connected to each other.

In the wireless network system according to the present invention, the fixed wireless access point further includes: a connection determination unit for determining whether interconnection between the mobile wireless access point and the fixed wireless access point via the second connection unit is established; and a transmission request transmitting unit for, if the connection determination unit determines that interconnection is established, transmitting to the mobile wireless access point via the second connection unit a request for transmission of the download request. In addition, the mobile wireless access point further includes transmission request reception means for receiving the transmission request. Further, the download-request transmitting unit, upon the transmission request being received, assumes that the mobile wireless access point and the fixed wireless access point are connected to each other via the first connection unit and transmits the download request to the fixed wireless access point via the first connection unit.

The configuration described above makes it possible to cause the mobile wireless access point to send a download request to the fixed wireless access point only when the mobile wireless access point and the fixed wireless access point are connected to each other. It is therefore possible to minimize transmission of a download request when the mobile wireless access point and the fixed wireless access point are not connected to each other. Further, the configuration makes it possible to cause the fixed wireless access point to determine whether the mobile wireless access point and the fixed wireless access point are connected to each other, enabling processing load imposed on the mobile wireless access point to be reduced.

In a wireless network system according to the present invention, the mobile wireless access point further includes a storage medium that includes the file storage unit and is freely attachable and detachable to and from the mobile wireless access point.

The configuration described above makes it possible to store a file in a file storage unit using a large-capacity storage medium even when a file of large size is downloaded.

In the wireless network system according to the present invention, the mobile wireless access point further includes a battery, a power reception unit for receiving power supplied from the fixed wireless access point when the mobile wireless access point and the fixed wireless access point are connected to each other via the first connection unit, and a first power feed unit for supplying the battery with power supplied via the power reception unit. In addition, the fixed wireless access point further includes a second power feed unit for supplying the mobile wireless access point with power when the mobile wireless access point and the fixed wireless access point are connected to each other via the second connection unit.

The configuration described above makes it possible to send a download request from the mobile wireless access point to the fixed wireless access point and store the downloaded file in the file storage unit when the mobile wireless access point is connected to the fixed wireless access point for charging the battery of the mobile wireless access point.

A mobile wireless access point according to the present invention is a mobile wireless access point for relaying client accessing of a first communications network, and is connectable to a fixed wireless access point, the fixed access point for relaying client accessing of a second communications network. The mobile wireless access point includes: a connection unit for connecting to the fixed wireless access point and enabling communications between the fixed and mobile access points; a download-request accepting unit for receiving from the client a download request that requests downloading of a file; a download-request transmitting unit for transmitting, when the mobile wireless access point and the fixed wireless access point are connected to each other via the connection unit, a received download request to the fixed wireless access point via the connection unit; a file storage unit for storing files; and a file-storage control unit for receiving, via the connection unit, a file transmitted from the fixed wireless access point, and storing the file in the file storage unit.

The configuration described above makes it possible to cause the mobile wireless access point to receive a download request from a client and send it to the fixed wireless access point when the mobile wireless access point and the fixed wireless access point are connected to each other. Therefore, the configuration makes it possible to cause the fixed wireless access point to download a file based on the received download request. This in turn enables the file downloading to be accomplished while keeping increase in load on the mobile wireless access point under control. The configuration also make it possible to keep increase in load imposed on the mobile wireless access point under control, making it possible to build in resources (e.g., CPU and memory) of lower-level performance (i.e., a CPU of slower-speed processing and memory of smaller capacity) in the mobile wireless access point. This in turn enables the mobile wireless access point to be smaller in size and lower in production cost. Furthermore, the mobile wireless access point according to the present invention has a file storage unit and a file-storage control unit, and therefore, when a file downloaded by the fixed wireless access point is sent to the mobile wireless access point, the file can be stored in the file storage unit. This in turn enables the mobile wireless access point to present a downloaded file to the client when the mobile wireless access point is detached from the fixed wireless access point or in a like situation.

A fixed wireless access point according to the present invention is a fixed wireless access point for relaying client accessing of a second communications network, and is connectable to a mobile wireless access point, the mobile access point for relaying client accessing of a first communications network. The fixed wireless access point includes: a connection unit for connecting to the mobile wireless access point and enabling communications between the mobile and fixed access points; a download-request receiving unit for receiving, when the mobile wireless access point and the fixed wireless access point are connected to each other via the connection unit, a transmitted file-download request from the mobile wireless access point via the connection unit; a file acquisition unit for downloading, based on a received download request, a file via the second communications network; and a file transmitting unit for transmitting, when the mobile wireless access point and the fixed wireless access point are connected to each other via the connection unit, the downloaded file to the mobile wireless access point via the connection unit.

The configuration described above makes it possible to receive a download request from a client at the fixed wireless access point via the mobile wireless access point. Further, at the fixed wireless access point, a file is downloaded based on the received download request, and the downloaded file is sent to the mobile wireless access point. This in turn enables the file downloading to be accomplished while controlling to a minimum increase in load on the mobile wireless access point. Further, the configuration makes it possible to control to a minimum increase in load on the mobile wireless access point, making it possible to build in resources (e.g., CPU and memory) of lower-level performance (i.e., a CPU of slower-speed processing and memory of smaller capacity) in the mobile wireless access point. This in turn enables the mobile wireless access point to be smaller in size and lower in production cost. Furthermore, the downloaded file is sent to the mobile wireless access point, and therefore the downloaded file for the client can be presented to the client from the mobile wireless access point when the mobile wireless access point is detached from the fixed wireless access point, or in a like situation, provided that the mobile wireless access point is capable of storing the downloaded file therein.

A method of controlling a wireless network system according to the present invention is a method of controlling a wireless network system constituted by a mobile wireless access point for relaying client accessing of a first communications network, and a fixed wireless access point for relaying client accessing of a second communications network. The wireless network system control method includes: (a) a step, in the mobile wireless access point, of receiving from the client a download request that requests downloading of a file; (b) a step, in the mobile wireless access point, of transmitting, when the mobile wireless access point and the fixed wireless access point are connected to each other via respective connection units, a received download request to the fixed wireless access point via the respective connection units; (c) a step, in the fixed wireless access point, of receiving, when the mobile wireless access point and the fixed wireless access point are connected to each other via the respective connection units, a transmitted download request from the mobile wireless access point via the respective connection units; (d) a step, in the fixed wireless access point, of downloading, based on a received download request, a file via the second communications network; (e) a step, in the fixed wireless access point, of transmitting, when the mobile wireless access point and the fixed wireless access point are connected to each other via the respective connection units, the downloaded file to the mobile wireless access point via the respective connection units; and (f) a step, in the mobile wireless access point, of receiving, via the respective connection units, a file transmitted from the fixed wireless access point, and storing the file in a file storage unit of the mobile wireless access point.

In the configuration described above, a download request from a client is received in the mobile wireless access point and is sent to the fixed wireless access point when the mobile wireless access point and the fixed wireless access point are connected to each other. In the fixed wireless access point, a file is downloaded based on the received download request, and the downloaded file is sent to the mobile wireless access point. Therefore, file downloading is realized in the fixed wireless access point, making it possible to download files while minimizing increase in load on the mobile wireless access point. Further, the fact that increase in load on the mobile wireless access point is controlled to a minimum means that resources (the CPU and memory, for example) of lower-level performance (a CPU of slower processing speed and memory of smaller capacity) can be built into the mobile wireless access point. This in turn enables the mobile wireless access point to be smaller in size and lower in production cost. What is more, since the downloaded file is stored in the file storage unit disposed in the mobile wireless access point, the downloaded file for the client can be presented to the client from the mobile wireless access point when the mobile wireless access point is detached from the fixed wireless access point or in a like situation.

A recording medium according to the present invention is a computer-readable non-volatile recording medium on which is recorded a program for controlling a mobile wireless access point, the mobile access point for relaying client accessing of a first communications network and connectable to a fixed wireless access point, the fixed access point for relaying client accessing of a second communications network. The program causes the mobile access point to realize: a function of receiving from the client a download request that requests downloading of a file; a function of transmitting, when the mobile wireless access point and the fixed wireless access point are connected to each other via respective connection units, a received download request to the fixed access point via the respective connection units; and a function of receiving, via the respective connection units, a file transmitted from the fixed wireless access point, and storing the file in a file storage unit of the mobile wireless access point.

In the configuration described above, a download request from a client is received in the mobile wireless access point and sent to the fixed wireless access point when the mobile wireless access point and the fixed wireless access point are connected to each other. This enables the fixed wireless access point to download a file based on the received download request. Therefore the downloading of files with minimal increase in load on the mobile wireless access point can be realized. Further, the fact that increase in load on the mobile wireless access point is controlled to a minimum means that resources (the CPU and memory, for example) of lower-level performance (a CPU of slower processing speed and memory of smaller capacity) can be built into the mobile wireless access point. This in turn enables the mobile wireless access point to be smaller in size and lower in production cost. Furthermore, files downloaded in the fixed wireless access point are sent to the mobile wireless access point to be stored in its file storage unit. Therefore, the downloaded file can be presented to the client from the mobile wireless access point when the mobile wireless access point is detached from the fixed wireless access point or in a like situation.

A recording medium according to the present invention is a computer-readable non-volatile recording medium on which is recorded a program for controlling a fixed wireless access point, the fixed access point for relaying client accessing of a second communications network and connectable to a mobile wireless access point, the mobile access point for relaying client accessing of a first communications network. The program causes the fixed wireless access point to realize: a function of receiving, when the mobile wireless access point and the fixed wireless access point are connected to each other via respective connection units, a transmitted download request from the mobile wireless access point via the respective connection units; a function of downloading, based on a received download request, a file via the second communications network; and a function of transmitting, when the mobile wireless access point and the fixed wireless access point are connected to each other via the respective connection units, the downloaded file to the mobile wireless access point via the respective connection units.

In the configuration described above, a download request from a client is received in the fixed wireless access point via the mobile wireless access point. Further, in the fixed wireless access point, files are downloaded and sent to the mobile wireless access point based on the received download request. Thus, since file downloading is executed in the fixed access point, the downloading of files with minimal increase in load on the mobile wireless access point can be realized. Further, the fact that increase in load on the mobile wireless access point is controlled to a minimum means that resources (the CPU and memory, for example) of lower-level performance (a CPU of slower processing speed and memory of smaller capacity) can be built into the mobile wireless access point. This in turn enables the mobile wireless access point to be smaller in size and lower in production cost. Furthermore, inasmuch as the downloaded file is sent to the mobile wireless access point, the downloaded file for the client can be presented to the client from the mobile wireless access point when the mobile wireless access point is detached from the fixed wireless access point, or in a like situation, provided that the mobile wireless access point is capable of storing the downloaded file therein.

It will be appreciated that the present invention can be realized through a variety of modes; realization through such modes as, for example, wireless-access-point control methods, computer programs for controlling wireless access points, and recording media on which the computer programs are recorded is possible.

### BRIEF DESCRIPTION OF THE DRAWINGS

FIG. 1 is a simplified explanatory diagram illustrating the configuration of a wireless network system as one embodiment of the present invention;

FIG. 2 is an explanatory diagram representing a second connection mode of the wireless network system;

FIG. 3 is a block diagram illustrating configurational details of a mobile access point of a first embodiment;

FIG. 4 is an explanatory diagram illustrating configurational details of a home gateway of the first embodiment;

FIG. 5 is a sequence chart representing procedural flows in a download request accepting process performed in the wireless network system of the first embodiment;

FIG. 6 is a first sequence chart representing procedural flows in a download process performed in the wireless network system of the first embodiment;

FIG. 7 is a second sequence chart representing procedural flows in the download process performed in the wireless network system of the first embodiment;

FIG. 8 is a block diagram illustrating configurational details of a mobile access point of a second embodiment;

FIG. 9 is a block diagram illustrating configurational details of a home gateway of the second embodiment;

FIG. 10 is a sequence chart representing procedural flows in a download process performed in a wireless network system of the second embodiment;

FIG. 11 is a flowchart representing procedural flows in a download request accepting process in a third embodiment;

FIG. 12 is an explanatory diagram representing an operation screen displayed on a client in Step S120;

FIG. 13 is a simplified explanatory diagram representing the configuration of a wireless network system of a fourth embodiment;

FIG. 14 is a block diagram illustrating configurational details of the cradle represented in FIG. 13;

FIG. 15 is a block diagram illustrating configurational details of a home gateway of a fourth embodiment; and

FIG. 16 is a flowchart representing procedural flows in a download request accepting process in a modification Example 12.

### DETAILED DESCRIPTION OF THE INVENTION

### A. First Embodiment

### A1. System Configuration

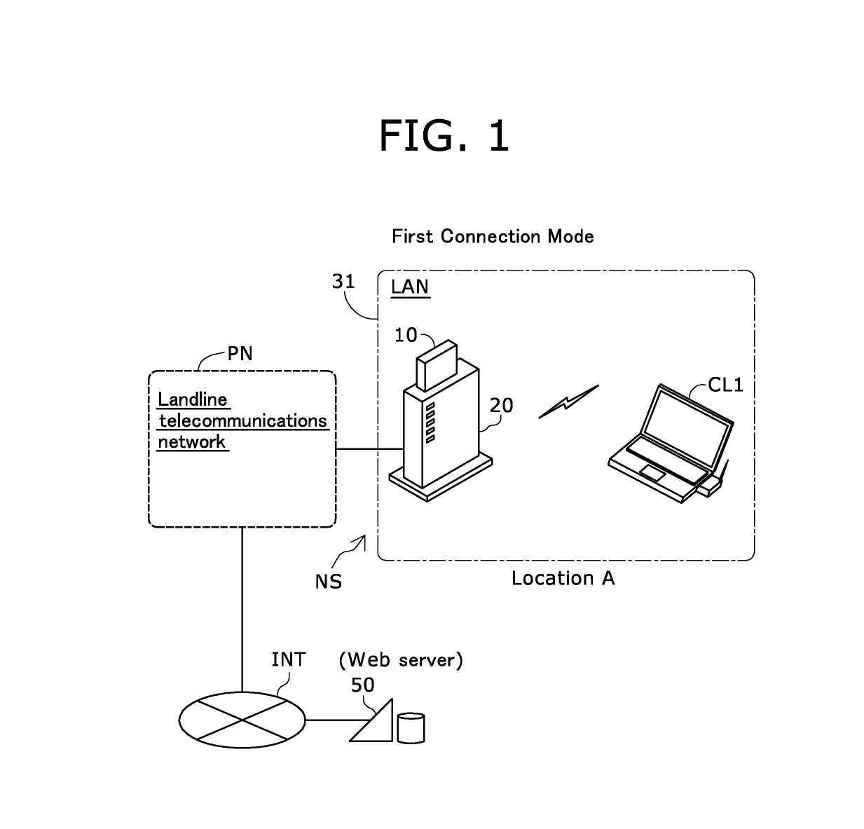

FIG. 1 is a simplified explanatory diagram illustrating the configuration of a wireless network system as one embodiment of the present invention. A wireless network system NS includes a home gateway 20 and a mobile access point 10. The wireless network system NS is a system for connecting a client CL1 to the Internet INT. Via the wireless network system NS and Internet INT, the client CL1 can download files stored in a server 50.

The wireless network system NS has a plurality of connection modes relating to the home gateway 20 and the mobile access point 10. In the connection mode (a first connection mode) illustrated in FIG. 1, the home gateway 20 is connected to the Internet INT via a landline (i.e., wired) communications network PN (e.g., optical lines employing optical fiber, asymmetric digital subscriber lines (ADSLs) employing metallic cable). In the first embodiment, the mobile access point 10 is physically connected to (in contact with) the home gateway 20. The reason for the mobile access point 10 being physically connected to the home gateway 20 is that the mobile access point 10 is driven with a battery as described later, and therefore the battery is to be charged via the home gateway 20. It should be noted that the wireless LAN communications function of the mobile access point 10 is halted in the first connection mode.

In the first connection mode, the mobile access point 10 and the home gateway 20 are both disposed in the same location (Location A). “Disposed in the same location” means that the devices are disposed physically adjoining each other. For example, according to the first connection mode of the present embodiment, the mobile access point 10 and the home gateway 20 are disposed physically adjoining each other in a user's home or at an away destination. Further in the first connection mode, the client CL1 is disposed physically adjoining the mobile access point 10 and the home gateway 20 (i.e., they are disposed in Location A). Specifically, for example, the client CL1 is disposed within a zone where the mobile access point 10 and the home gateway 20 are capable of receiving a radio signal output from the client CL1 in the user's home or at the away destination. In the first connection mode, the home gateway 20 and the client CL1 form a wireless LAN 31 in Location A. Specifically, the home gateway 20 operates as a wireless LAN access point, while the client CL1 operates as a wireless LAN client. Further in the first connection mode, the home gateway 20 also functions as a router, outputs a Layer 3 packet to the landline communications network PN, the packet being received from the client CL1, and relays a Layer 3 packet to the client CL1, the packet being received from the landline communications network PN. According to the present embodiment, the client CL1 is a typical personal computer (PC) functioning as a wireless LAN client, and therefore a description thereof will not be made here. It will be appreciated that game machines, mobile telephone terminals or the like may be adopted instead of the personal computer as the client CL1.

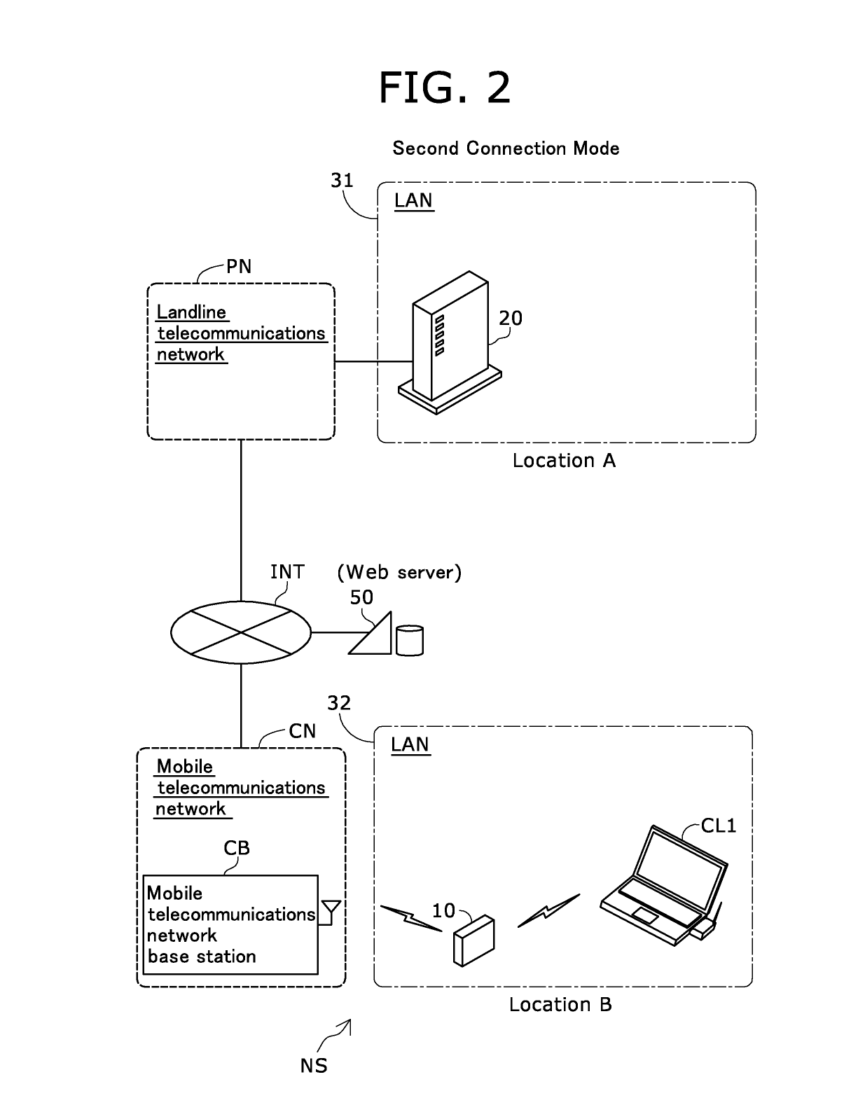

FIG. 2 is an explanatory diagram representing a second connection mode of the wireless network system. In the second connection mode, the mobile access point 10 and the home gateway 20 are disposed in two respectively different locations. Specifically, the home gateway 20 is disposed in the location A as shown in the upper part of FIG. 2, while the mobile access point 10 and client CL1 are disposed in the location B as shown in the lower part of FIG. 2. Here, in the second connection mode, the location A is physically substantially apart from the location B, wherein the client CL1 and the gateway 20 are disposed apart from each other—for example, at a user's home and at an away destination, etc.—to an extent that a radio signal output from either one of them cannot be received by the other.

In the second connection mode, the mobile access point 10 and the client CL1 form a wireless LAN 32 in the location B. Specifically, in the second connection mode the mobile access point 10 operates as a wireless LAN access point while the client CL1 operates as a wireless LAN client. The mobile access point 10 has functionality for performing wireless communications with mobile base stations CB in a mobile telecommunications network CN and that of a router, in addition to having the functionality of a wireless LAN access point. It will be appreciated that the mobile telecommunications network CN may adopt, for example, a third-generation (3G)/high speed packet access (HSPA) line. In the second connection mode, the client CL1 is capable of connecting to the Internet INT via both the mobile access point 10 and the mobile telecommunications network CN. A communications band of the mobile telecommunications network CN is generally narrower than that of the landline communications network PN, and therefore a the speed at which files download from the server 50 in the second connection mode is slower than the speed at which files download from the server 50 in the first connection mode represented in FIG. 1.

The second connection mode can form, for example, when a user detaches the mobile access point 10 from the home gateway 20 and moves the client CL1 and the mobile access point 10 to Location B, transitioning from the first connection mode shown in FIG. 1. Further, the first connection mode can form, for example, when a user brings back the client CL1 and the mobile access point 10 to Location A and connects the mobile access point 10 to the home gateway 20, transitioning from the second connection mode shown in FIG. 2.

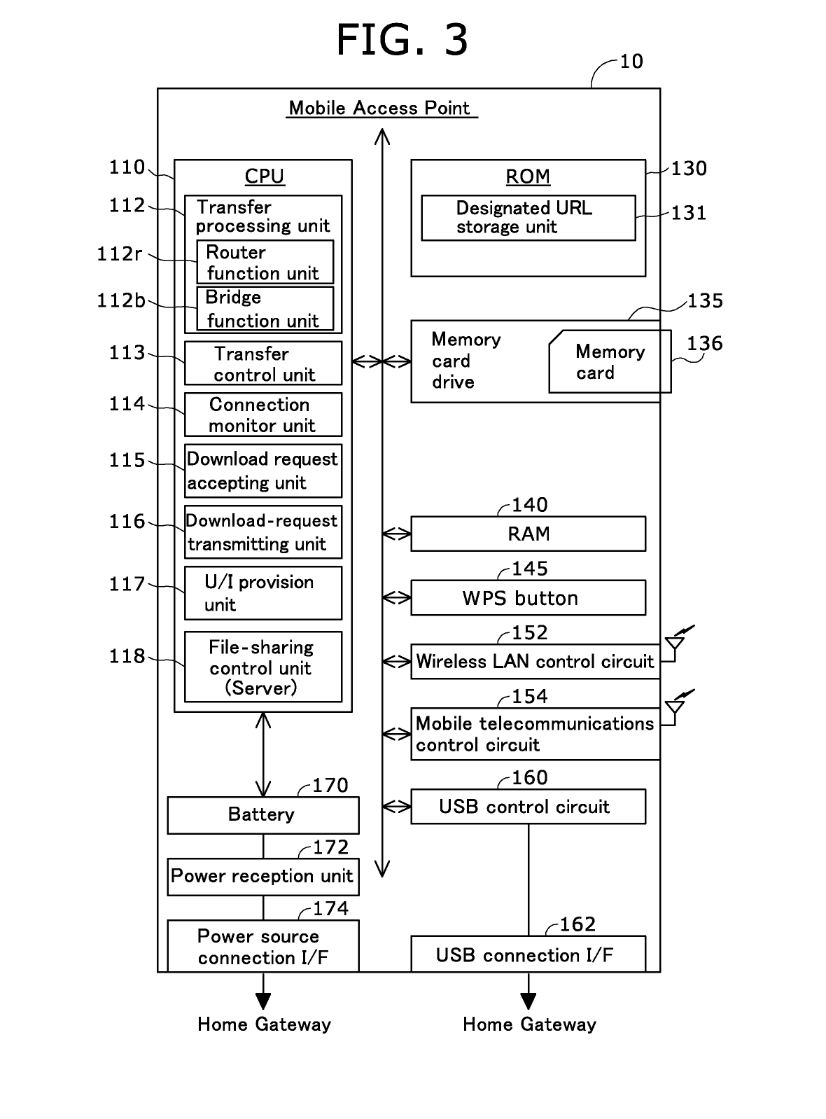

FIG. 3 is a block diagram illustrating configurational details of a mobile access point of the first embodiment. The mobile access point 10 includes a central processing unit (CPU) 110, read only memory (ROM) 130, a memory card drive 135, random access memory (RAM) 140, a Wi-Fi protected setup (WPC) button 145, a wireless LAN control circuit 152, a mobile telecommunications control circuit 154, a universal serial bus (USB) control circuit 160, a USB connection interface (I/F) 162, a battery 170, a power reception unit 172, and a power source connection I/F 174. The mobile access point 10 is compact, lightweight and excels in portability.

The CPU 110 executes a packet-relaying application program stored in the ROM 130, thereby functioning as a transfer processing unit 112 and a transfer control unit 113. The transfer processing unit 112 includes a router function unit 112r and a bridge function unit 112b, and in accordance with the destination address transfers packets (Layer 3 packets and Layer 2 frames) input via the respective communications interfaces (the wireless LAN control circuit 152, the mobile telecommunications control circuit 154, and the USB connection I/F 162). The transfer control unit 113 controls the transfer processing unit 112.

Further, the CPU 110 executes a program adapted for accepting a file-download request, the program being stored in the ROM 130, thereby functioning as a connection monitor unit 114, a download request accepting unit 115, a download-request transmitting unit 116, and a user interface (U/I) provision unit 117. The connection monitor unit 114 monitors connection of the mobile access point 10 to the home gateway 20. The download request accepting unit 115 accepts a file-download request sent from the client CL1. In a download process (described later), the download-request transmitting unit 116 sends to the home gateway 20 a download request accepted from the client CL1. The U/I provision unit 117 causes the client CL1 to display an operation screen adapted for accepting a download request.

Further, the CPU 110 executes a file-sharing program stored in the ROM 130, thereby functioning as a file-sharing control unit 118. It is possible to adopt, for example, a program adapted for realizing a file-sharing protocol such as a Common Internet File System (CIFS) as the file-sharing program. In the case of adopting a program for realizing the CIFS, the file-sharing control unit 118 functions as a CIFS server.

The ROM 130 includes a designated uniform resource locator (URL) storage unit 131 in addition to storing therein the aforementioned individual programs. In a download request accepting process (described later), the designated URL storage unit 131 stores a URL, which is file-specifying information, included in a file-download request sent from the client CL1.

The memory card drive 135 reads data from a memory card 136 to be inserted into a slot (not shown herein) and writes data to the memory card 136. For the memory card 136, any storage medium of choice may be adopted—for example, a secure digital (SD) memory card, a Compact Flash (registered trademark) memory card, or a smart medium, which is freely detachably attached to the mobile access point 10.

The WPS button 145 is a button that is in compliance with a specification prescribed by the Wi-Fi alliance and is adapted for notifying a client CL1 of various kinds of setup information (e.g., service set identifier (SSID), security class, and security key) used for wireless communications so that the client may be configured with the setup information.

The wireless LAN control circuit 152 includes a modulator, an amplifier and an antenna, operates as an access point of a wireless LAN in compliance with, for example, IEEE 802.11a/b/g, and wirelessly communicates with a wireless LAN client. The mobile telecommunications control circuit 154 includes a modulator, an amplifier, and an antenna. The circuit functions as a terminal device of a mobile telecommunications in compliance with, for example, 3G/HSPA and wirelessly communicates with a base station of a mobile telecommunications network.

The USB control circuit 160 controls exchange of data in compliance with the USB standard. The USB connection I/F 162 is connected to the USB control circuit 160 and constitutes a physical connection I/F group compliant with the USB standard. The USB connection I/F 162 is connected to (contacted with) a USB connection I/F (described later) of the home gateway 20 when the mobile access point 10 is connected thereto. The power reception unit 172 receives power supplied from the home gateway 20 via the power source connection I/F 174 and supplies the battery 170 with the power. The power source connection I/F 174 is connected to (contacted with) a power source connection I/F (described later) of the home gateway 20 when the mobile access point 10 is connected thereto. The power source connection I/F 174 transfers power to the power reception unit 172, the power being supplied via the power source connection I/F (described later) of the home gateway 20.

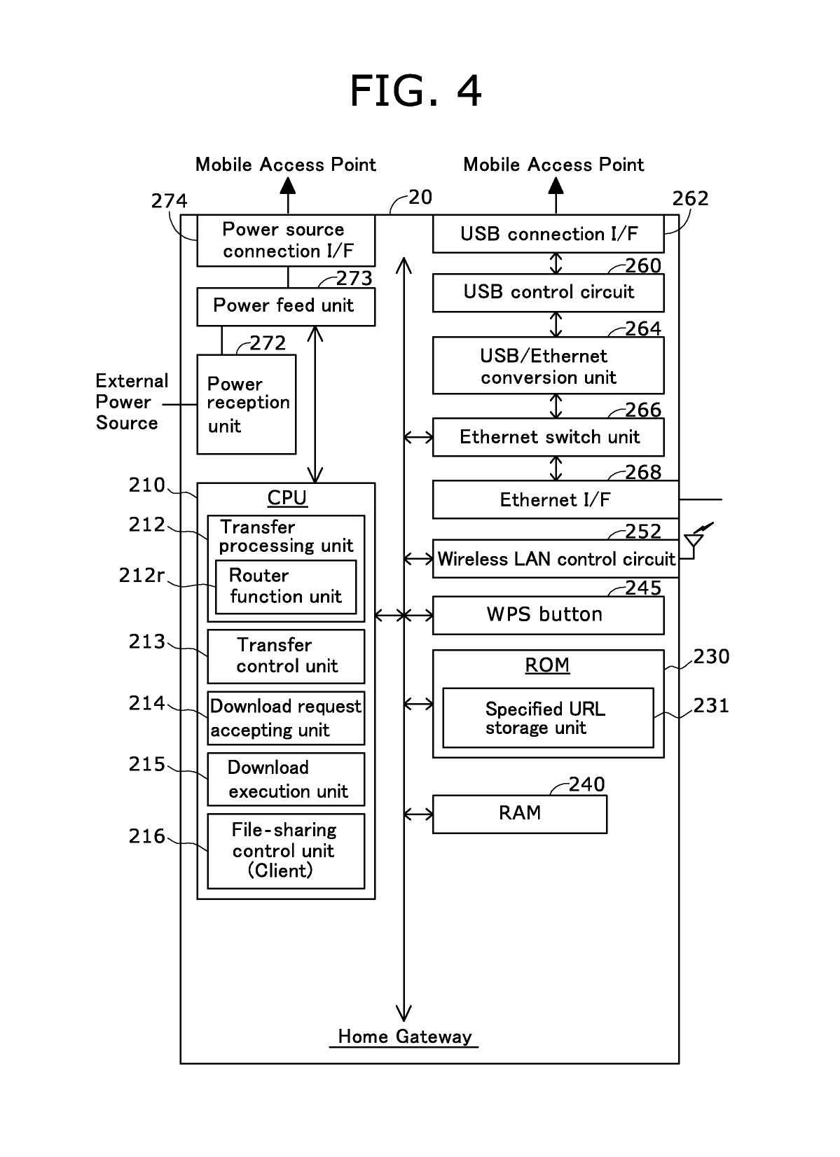

FIG. 4 is an explanatory diagram illustrating configurational details of a home gateway of the first embodiment. The home gateway 20 includes a CPU 210, ROM 230, RAM 240, a WPS button 245, a wireless LAN control circuit 252, a USB control circuit 260, a USB connection I/F 262, an Ethernet (registered trademark) I/F 268, an Ethernet switch unit 266, a USB/Ethernet conversion unit 264, a power reception unit 272, a power feed unit 273, and a power source connection I/F 274. The home gateway 20 is larger in size and heavier than the mobile access point 10 and is connected to the landline communications network PN, and therefore is stationarily disposed in the location A.

The CPU 210 executes a packet relaying application program stored in the ROM 230, thereby functioning as a transfer processing unit 212 and a transfer control unit 213. The transfer processing unit 212 includes a router function unit 212r. The transfer processing unit 212 is similar to the transfer processing unit 112 of the mobile access point 10 shown in FIG. 3, and therefore a description thereof will not be made here. Likewise, the router function unit 212r and the transfer control unit 213 are respectively similar to the router function unit 112r and transfer control unit 113 of the mobile access point 10 shown in FIG. 3, and therefore descriptions thereof will not be made here.

Further the CPU 210 executes a file download program stored in the ROM 230, thereby functioning as a download request accepting unit 214 and a download execution unit 215. The download request accepting unit 214 accepts a download request sent from the mobile access point 10 in a download process (described later). In the later-described download process, the download execution unit 215 downloads a file from the server 50 in accordance with a designated URL.

The CPU 210 further executes a file sharing program stored in the ROM 230, thereby functioning as a file-sharing control unit 216. For the file-sharing program, for example, a program such as the Common Internet File System (CIFS) for realizing protocols for sharing files may be adopted. Here, in the case of adopting a program for realizing the CIFS, the file-sharing control unit 216 functions as a CIFS client.

The ROM 230 includes a designated URL storage unit 231 in addition to storing therein the aforementioned individual programs. The designated URL storage unit 231 stores therein a URL included in a download request sent from the mobile access point 10 in the later-described download process.

It will be appreciated that the individual resources (i.e., CPU 210 and ROM 230) included in the home gateway 20 have higher levels of processing performance than those of the individual resources (i.e., CPU 110 and ROM 130) included in the mobile access point 10. The reasons for this include that since the mounting space restrictions on the home gateway 20 are looser by comparison to those on the mobile access point 10, a larger number of ROMs may be built into the gateway, and since a larger size heat sink may be built into it, the gateway may be equipped with a CPU whose heating up, with the processing speed being high, is tolerable.

The ROM 230 includes a designated URL storage unit 231 in addition to storing therein the aforementioned individual applications. The designated URL storage unit 231 stores therein a URL included in a download request sent from the mobile access point 10 in the later-described download process.

The WPS button 245 is the same as the WPS button 145 of the mobile access point 10 shown in FIG. 3, and therefore a description thereof will not be made here. Likewise, the wireless LAN control circuit 252 and the USB control circuit 260 are respectively similar to the wireless LAN control circuit 152 and the USB control circuit 160 of the mobile access point 10 shown in FIG. 3, and therefore descriptions thereof will not be made here.

The USB connection I/F 262 constitutes a physical connection I/F group in compliance with the USB standard and is connected to (contacted with) the USB connection I/F 162 of the mobile access point 10 when it is connected to the home gateway 20.

The Ethernet I/F 268 processes the Layer 1 and 2 protocols of the Ethernet. The Ethernet I/F 268 is connected to a network cable for connecting to an access line (not shown) of a landline communications network PN. The Ethernet switch unit 266 is connected to the Ethernet I/F 268 and the USB/Ethernet conversion unit 264. The Ethernet switch unit 266 relays an Ethernet frame input from the Ethernet I/F 268 and the USB/Ethernet conversion unit 264 in accordance with a destination Media Access Control (MAC) address.

The USB/Ethernet conversion unit 264 is connected to the USB control circuit 260 and the USB/Ethernet conversion unit 264. The USB/Ethernet conversion unit 264 converts a USB packet received from the USB control circuit 260 into an Ethernet frame and outputs it to the Ethernet switch unit 266. Further, the USB/Ethernet conversion unit 264 converts an Ethernet frame received from the Ethernet switch unit 266 into a USB packet and outputs it to the USB control circuit 260.

The power reception unit 272 receives power supplied from an external power source and supplies the power to the power feed unit 273. The power feed unit 273 supplies the power received from the power reception unit 272 to the home gateway 20 via the power source connection I/F 274 when the mobile access point 10 is connected to the home gateway 20.

The wireless network system NS configured as described above performs a download request accepting process and a downloading process (both later-described) when a file-download request is received from a client CL1 in the second connection mode, thereby accomplishing the download while minimizing increase in load on the mobile access point 10.

### A2. Download Request Accepting Process

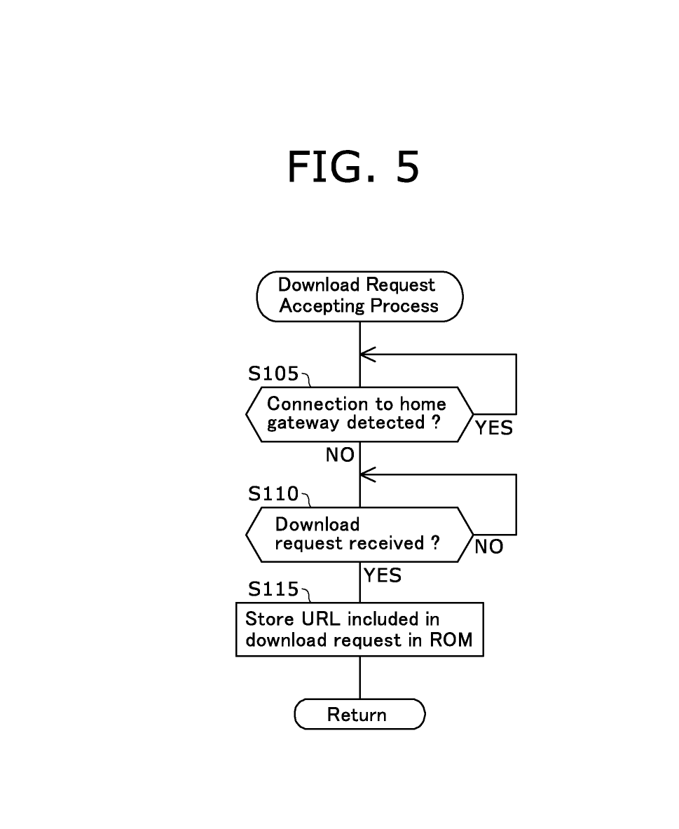

FIG. 5 is a sequence chart representing procedural flows in a download request accepting process performed in the wireless network system of the first embodiment. When the power to the mobile access point 10 is turned on, the download request accepting process is performed therein.

In the mobile access point 10, the connection monitor unit 114 monitors whether the mobile access point 10 is connected to the home gateway 20 (Step S105; also simply “S105” hereinafter). The monitoring may be realized by, for example, the presence of power feed to the power source connection I/F 174, or by using, for example, a sequence for detecting connection between devices in accordance with the USB standard.

At the mobile access point 10, if connection to the home gateway 20 is not detected (“NO” for S105), the download request accepting unit 115 monitors whether a download request is received from the client CL1 (S110). In the first connection mode, the wireless LAN communications function of the mobile access point 10 is halted, and therefore a download request for a file is not received from the client CL1. In contrast in the second connection mode, the wireless LAN communications function (i.e., the wireless LAN access point function) of the mobile access point 10 is operating, and therefore a download request for a file can be received from the client CL1. It should be noted that a file-download request from the client CL1 is sent to the mobile access point 10 therefrom when, for example, a URL for specifying a file in the server 50 and a download execution instruction are input in a Web browser of the client CL1.

At the mobile access point 10, upon receiving a file-download request from the client CL1 (“YES” for S110), the download request accepting unit 115 stores a URL included in the download request in the designated URL storage unit 131 (S115).

When detecting connection to the home gateway 20 in the above described step S105 (“YES” for S105), the download request accepting unit 115 stands by until it no longer detects the connection. Further, if detecting no reception of a download request in the above described step S110 (“NO” for S110), the download request accepting unit 115 stands by until it detects reception of a download request.

As described above, at the mobile access point 10, when a file-download request is received from the client CL1, a designated URL included in the download request is stored in the designated URL storage unit 131. A file specified by the designated URL, however, is not downloaded at once, but is downloaded in the later-described download process.

### A3. Download Process

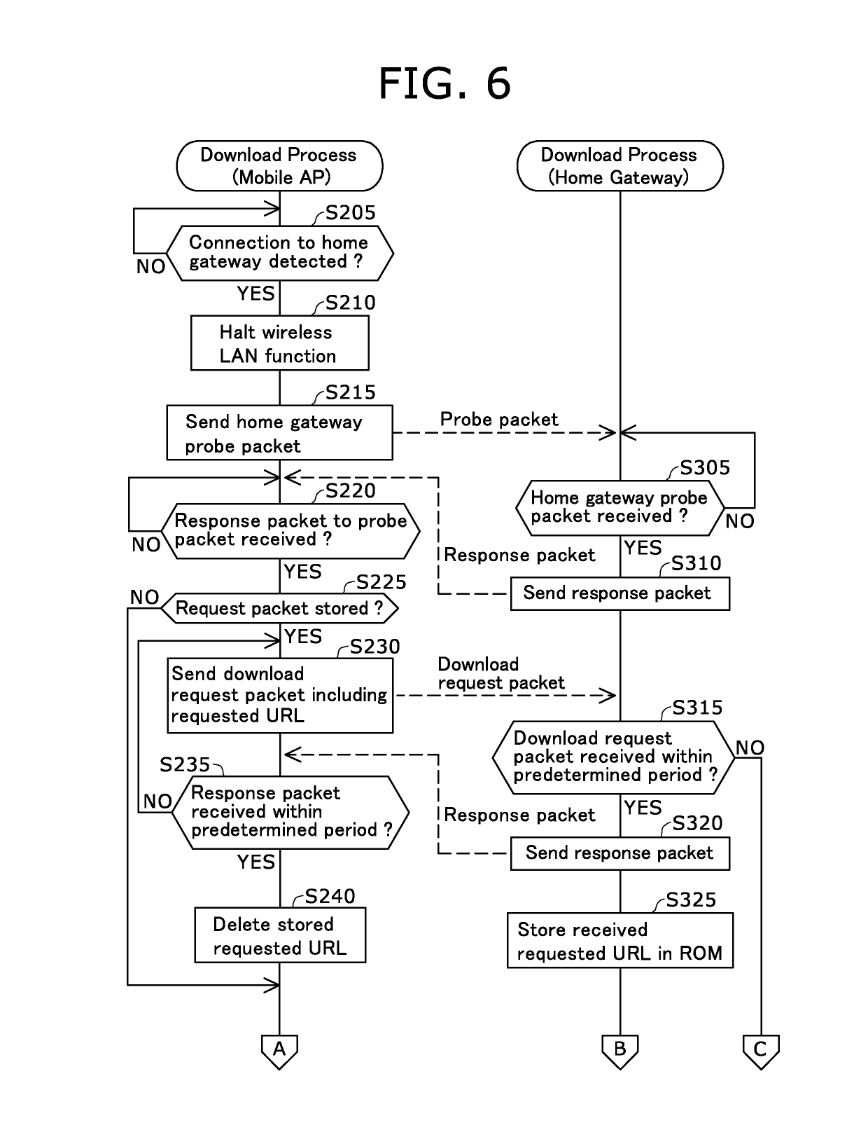

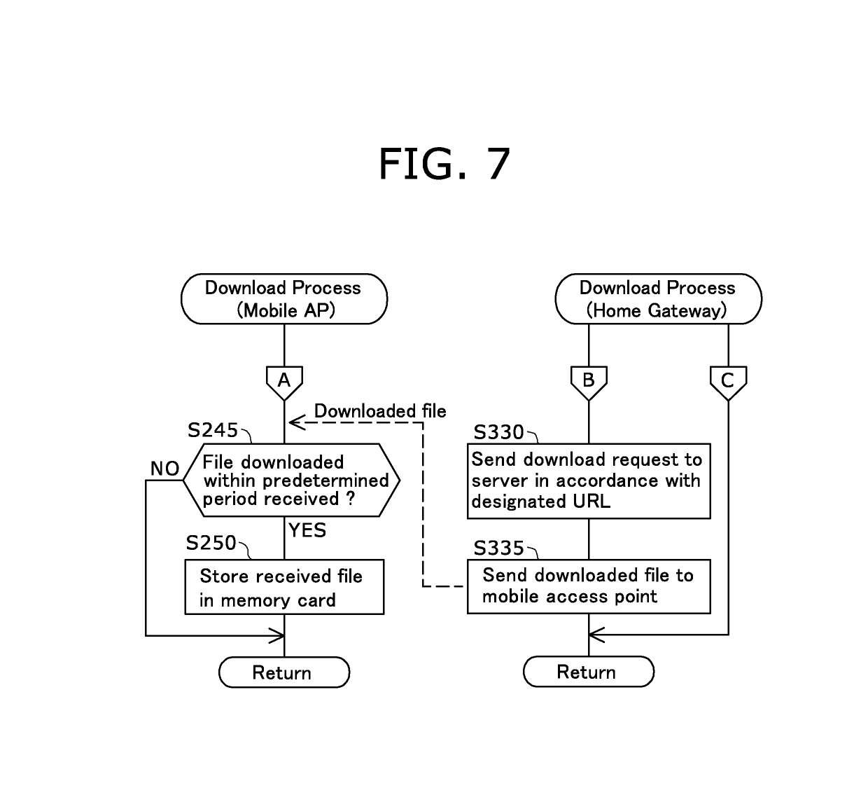

FIG. 6 is a first sequence chart representing procedural flows in a download process performed in the wireless network system of the first embodiment. FIG. 7 is a second sequence chart representing procedural flows in the download process performed in the wireless network system of the first embodiment. Referring to each of FIGS. 6 and 7, the left side is a sequence chart representing the procedural flow performed in the mobile access point 10, while the right side is a sequence chart representing the procedural flow performed in the home gateway 20. The sequence shown in FIG. 7 is performed following the sequence shown in FIG. 6. At both the mobile access point 10 and the home gateway 20, the download processes are respectively performed when the power to them is respectively turned on.

As shown in FIG. 6, at the mobile access point 10, the connection monitor unit 114 monitors whether the mobile access point 10 is connected to the home gateway 20 (S205). The processing is the same as that of step S105 of the above described download request accepting process, and therefore a description thereof is not made here.

At the mobile access point 10, when connection between the mobile access point 10 and the home gateway 20 is detected (“YES” for S205), the transfer control unit 113 causes the wireless LAN control circuit 152 to stop operating (S210). For example, when the mobile access point 10 and the client CL1 return to the location A, transitioning to the first connection mode shown in FIG. 1 from the second connection mode shown in FIG. 2, it is determined as an event of connecting the mobile access point 10 to the home gateway 20 so that the wireless communications function (i.e., the function as a wireless LAN access point) of the mobile access point 10 is halted. The reason for the wireless communications function of the mobile access point 10 being halted when it is determined as an event of connecting the mobile access point 10 to the home gateway 20 is to suppress generation of noise interference or radio-wave interference between the mobile access point 10 and the home gateway 20.

At the mobile access point 10, the download-request transmitting unit 116 controls the USB control circuit 160 so as to output (i.e., broadcast) a home gateway search packet via the USB connection I/F 162 (S215). The home gateway search packet includes the MAC address of the mobile access point 10.

At the home gateway 20, after the power thereto is turned on, the download request accepting unit 214 monitors reception of a home gateway search packet via the USB connection I/F 262 (S305). Upon detecting reception of a home gateway search packet (“YES” for S305), the download request accepting unit 214 sends (i.e., responds with) a response packet using the MAC address included in the received packet as a destination address (S310). The response packet includes the MAC address of the home gateway 20.

At the mobile access point 10, the download-request transmitting unit 116 stands by (Step S220) until reception of a response packet, after sending the home gateway search packet (i.e., after the above described S215). When detecting the reception of the response packet (“YES” for S220), the download-request transmitting unit 116 determines whether a URL is stored in the designated URL storage unit 131 (S225). If it is determined that the URL is stored in the designated URL storage unit 131 (“YES” for S225), the download-request transmitting unit 116 sends a file-download request packet to the home gateway 20 via the USB connection I/F 162, the packet including the URL stored in the designated URL storage unit 131 (S230).

At the home gateway 20, the download request accepting unit 214 monitors reception of a download request packet within a predetermined period (S315) after sending the response packet (i.e., after the above described S310). If a download request packet is not received within the predetermined period (“NO” for S315), the processing reverts back to the above described step S305 as shown in FIG. 7. In contrast, if a download request packet is received within the predetermined period (“YES” for S315), the download request accepting unit 214 sends a response packet to the mobile access point 10 (S320).

At the mobile access point 10, the download-request transmitting unit 116 determines whether a response packet from the home gateway 20 has been received within a predetermined period (S235) after the above described S230, and, if not a response packet has not been received within the predetermined period (“NO” for S235), returns to step S230 to re-sends the download request packet to the home gateway 20. In contrast, if a response packet has been received within the predetermined period (“YES” for S235), the file-sharing control unit 118 deletes the URL stored in the designated URL storage unit 131 (S240).

At the home gateway 20, the download request accepting unit 214 stores the designated URL received from the mobile access point 10 in the designated URL storage unit 231 (S325) after sending a response packet (i.e., after the above described S320). At the home gateway 20, the download execution unit 215 sends a file-download request to the server 50, as the destination, in accordance with the designated URL stored in the designated URL storage unit 231 (S330), as indicated in FIG. 7.

The download request destined to the server 50 is output to the landline communications network PN via the Ethernet I/F 268 and is received by the server 50 via the landline communications network PN and Internet INT. A file sent (i.e., downloaded) from the server 50 reaches the home gateway 20 via the Internet INT and the landline communications network PN. As described above, the wireless network system NS is configured so that both transmission of a file-download request to the server 50 and downloading of a file therefrom are performed via the landline communications network PN. The reason for the aforementioned procedure is to make it possible to accomplish a high-speed download by downloading a file via a communications network having a wider communications band than the mobile telecommunications network CN does. In addition, both the transmission of a file-download request to the server 50 and the downloading of a file therefrom are carried out at the home gateway 20. The reason is to make it possible to realize a high-speed download by downloading the file on a device having resources (e.g., CPU and ROM) with higher levels of performance.

At the home gateway 20, the file-sharing control unit 216 sends the file downloaded from the server 50 to the mobile access point 10 via the USB connection I/F 262 (S335), and again the processing returns to the above described S305.

As shown in FIG. 7, at the mobile access point 10, after the above described S240, or if it is determined that the URL is not stored in the designated URL storage unit 131 in the above described step S225 (“NO” for S225), the file-sharing control unit 118 determines whether a downloaded file is received within a predetermined period (S245). If a downloaded file is received within the predetermined period (“YES” for S245), the file-sharing control unit 118 stores the received file in the memory card 136 (S250). The reason for storing the file in the memory card 136 is to make it possible to present the client CL1 with the file stored in the memory card 136 after the mobile access point 10 is detached from the home gateway 20; that is, the second connection mode is changed to the first connection mode. In the above described S245, if it is determined that a downloaded file is not received within the predetermined period (“NO” for S245), the processing is returned to the above described step S205.

As described above, the wireless network system NS of the first embodiment is configured so that, if a download request from the client CL1 is received at the mobile access point 10 in the second connection mode and if the mobile access point 10 is physically connected to the home gateway 20, a download request including a URL designated by the request is sent to the home gateway 20. The home gateway 20 then downloads, from the server 50, a file specified by the designated URL received from the mobile access point 10. Therefore, the a file is downloaded at the home gateway 20, making it possible to accomplish the downloading of the file while minimizing increase in processing load on the mobile access point 10. This in turn makes it possible to keep the residual capacity of the battery 170 from being substantially reduced and to minimize influence on other communications if the mobile access point 10 is processing other communications.

In addition, it is configured so that a file is downloaded at the home gateway 20 via the landline communications network PN having a relatively wide communications band, and thereby a high-speed download is accomplished. Further, the home gateway 20 has resources (e.g., a CPU and ROM) with higher levels of performance than the mobile access point 10 does, thereby accomplishing a high-speed download. Therefore, the wireless network system NS of the first embodiment makes it possible to shorten the time required for a download process when there is a file-download request from the client CL1 connected to the mobile access point 10 in the second connection mode.

Further, the downloaded file is stored in the memory card 136 attached to the mobile access point 10, making it possible to provide the downloaded file to the client CL1 from the mobile access point 10 in the case of transitioning from the first connection mode to the second connection mode or in the like situation. Therefore, the wireless network system NS of the first embodiment is capable of realizing, for example, the usage modes as follows. If the second connection mode is established at a location (e.g., underground) where the mobile access point 10 is not enabled to connect to a mobile telecommunications network CN and if there is a request from the client CL1 for downloading of a file, the file is downloaded when the mobile access point 10 is connected to the home gateway 20 for charging the battery 170 of the mobile access point 10. Afterwards, when the second connection mode is re-established, the file is supplied to the client CL1 from the mobile access point 10. Such a usage mode allows a user to browse a file or conduct a similar activity even if a location where the second connection mode is re-established is underground or the like.

Further, a large scale file can be downloaded and stored by using a memory card with a large-scale memory space, because the memory card 136 is the destination of storing the downloaded file.

Further, since the wireless communications function of the mobile access point 10 is halted when the mobile access point 10 and the home gateway 20 are connected to each other, situations where the client CL1, not understanding with which device it should communicate, is unable to send a download request may be kept to a minimum.

### B. Second Embodiment

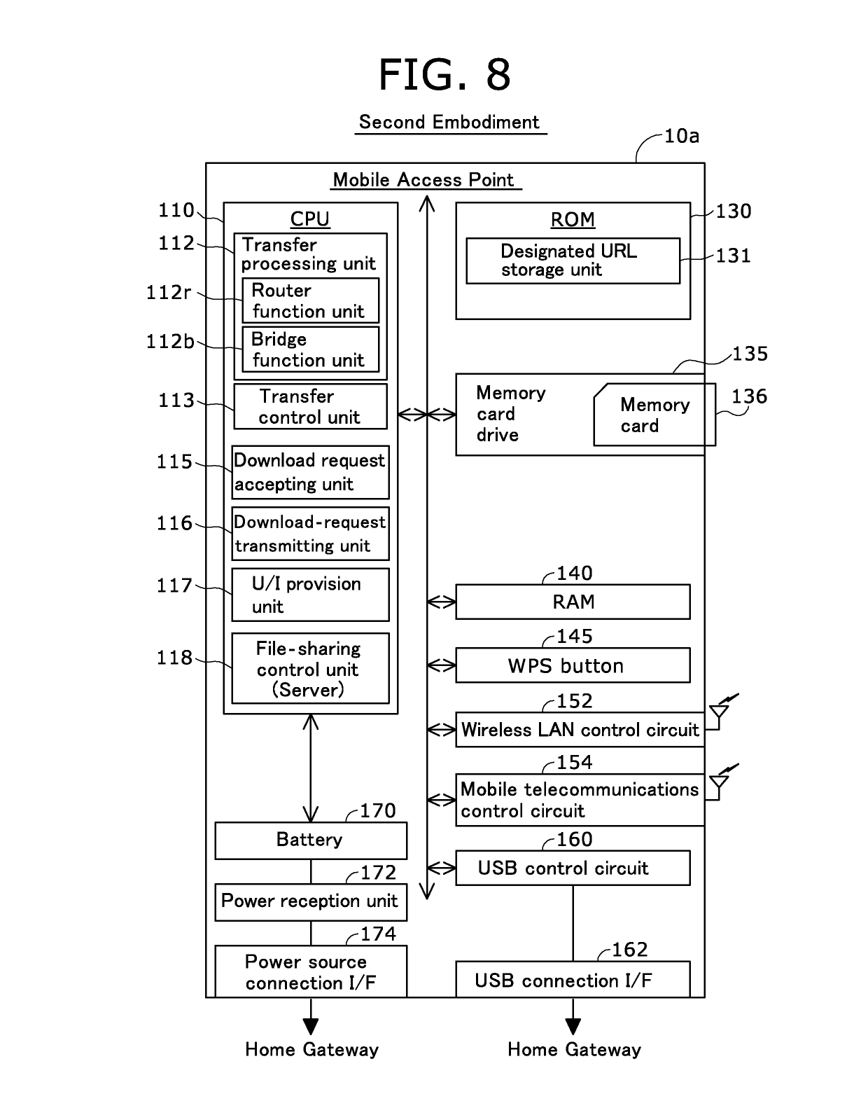

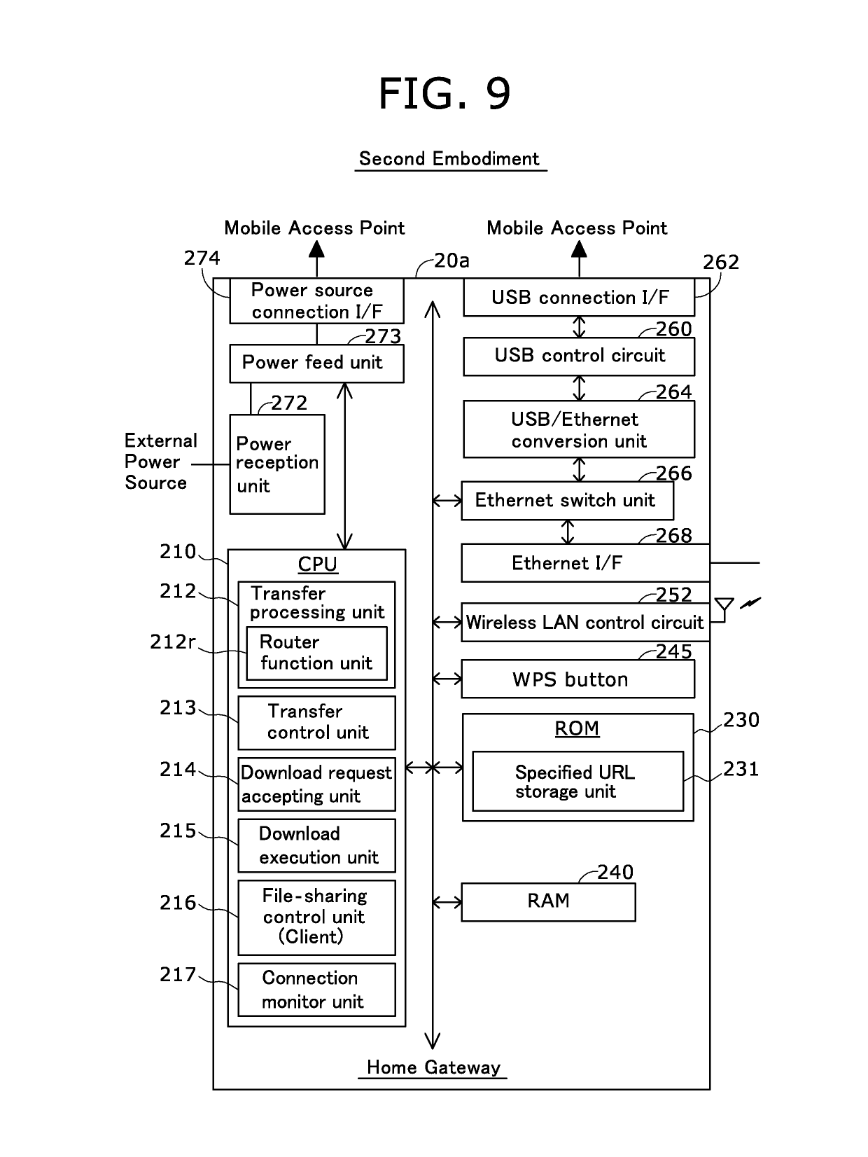

FIG. 8 is a block diagram illustrating configurational details of a mobile access point of a second embodiment. FIG. 9 is a block diagram illustrating configurational details of a home gateway of the second embodiment. The mobile access point 10a illustrate in FIG. 8 is different from the mobile access point 10 of the first embodiment shown in FIG. 3, where the former is configured to include a CPU 110 that has no functionality of a connection monitor unit. Otherwise, the configuration of the mobile access point 10a is the same as that of the mobile access point 10 of the first embodiment. The home gateway 20a illustrated in FIG. 9 is different from the home gateway 20 of the first embodiment shown in FIG. 4, where the former is configured to include a CPU 210 that functions as a connection monitor unit 217. Otherwise, the configuration of the home gateway 20a is the same as the home gateway 20 of the first embodiment.

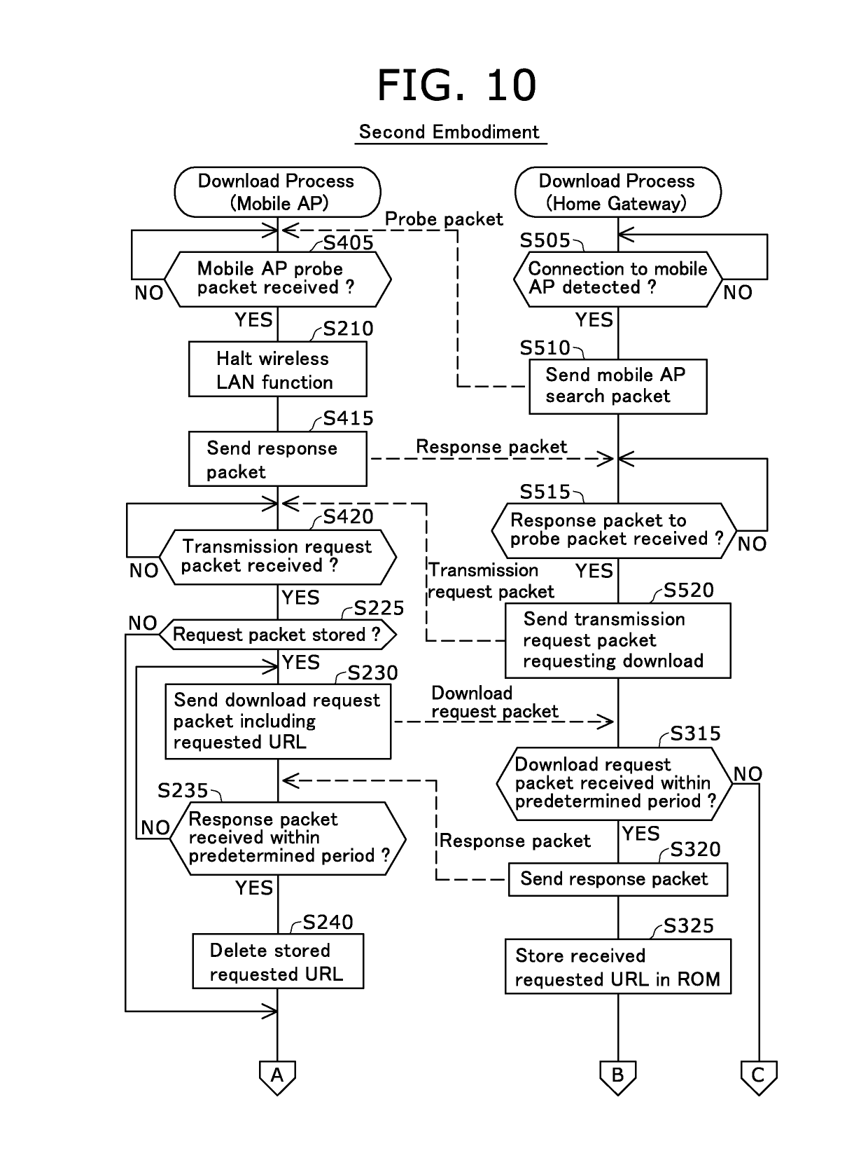

FIG. 10 is a sequence chart representing procedural flows in a download process performed in a wireless network system of the second embodiment. Referring to FIG. 10, the left side and the right side are the same as the left and right sides of the sequence chart of the first embodiment shown in FIG. 6, and therefore the description is not provided herein. It is noted that the sequence shown in FIG. 10 is followed by executing the above described sequence shown in FIG. 7. The wireless network system of the second embodiment is configured so that, when the mobile access point 10a is connected to the home gateway 20a, a request for sending a download request is sent to the mobile access point 10a from the home gateway 20a, and a download request is sent from the mobile access point 10a to the home gateway 20a in response to the request.

Specifically, at the home gateway 20a, the connection monitor unit 217 monitors whether the mobile access point 10a is connected to the home gateway 20a (S505). The processing is similar to that of step S205 of the first embodiment shown in FIG. 6.

In step S505, when connection of the mobile access point 10a to the home gateway 20a is detected (Yes for S505), the download request accepting unit 214 of the home gateway 20a sends (i.e., broadcasts) a mobile access point search packet via the USB connection I/F 262 (S510). The processing is similar to that of step S215 shown in FIG. 6.

At the mobile access point 10a, the download-request transmitting unit 116 monitors reception of a mobile access point search packet via the USB connection I/F 162 (S405) after the power to the mobile access point 10a is turned on. Upon detecting the reception of the mobile access point search packet (Yes for S405), the download-request transmitting unit 116 perform the above described step S210 (i.e., stopping the wireless LAN function) and sends a response packet to the home gateway 20a (S415).

At the home gateway 20a, the download request accepting unit 214 stands by until receiving a response packet (S515) after the above described step S510. Upon receiving the response packet (Yes for S515), the download request accepting unit 214 sends, to the mobile access point 10a via the USB connection I/F 262, a transmission request packet that requests transmission of a download request (S520). After the processing of step S520 is performed, the processing of step S315 and thereafter are carried out at the home gateway 20a.

At the mobile access point 10a, the download-request transmitting unit 116 stands by until reception of the transmission request packet that requests transmission of a download request (S420) after the above described step S415. Upon receiving the transmission request packet requesting transmission of a download request (“YES” for S420), the download-request transmitting unit 116 perform the processing of the above described step S225. Then the processing of step S230 and thereafter are carried out at the mobile access point 10a.

The wireless network system of the second embodiment configured as described above produces the same effectiveness as the wireless network system NS of the first embodiment does. In addition, loads on the mobile access point 10a can be reduced because it has no functionality of monitoring connection to the home gateway 20a or actively sending a set of wireless communication setup information.

### C. Third Embodiment

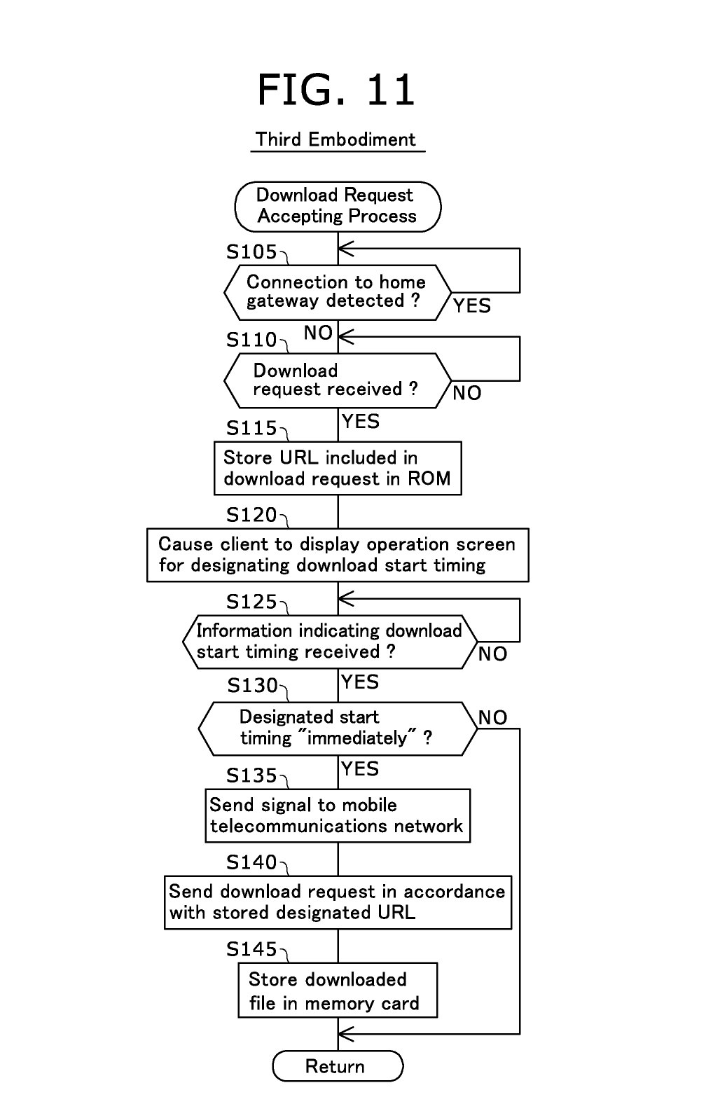

FIG. 11 is a flowchart representing procedural flows in a download request accepting process in a third embodiment. A wireless network system of the third embodiment is different from the wireless network system NS of the first embodiment where the former is configured to download a file at the mobile access point 10 if a predetermined condition is satisfied in the second connection mode. Otherwise, the configuration of the wireless network system of the present embodiment is the same as that of the wireless network system NS of the first embodiment.

As shown in FIG. 11, the download request accepting process of the third embodiment is different from the download request accepting process of the first embodiment shown in FIG. 5 where the former is configured to carry out additional steps S120 through S145 and is otherwise the same as the first embodiment.

At the mobile access point 10, when a URL included in the download request is stored in the designated URL storage unit 131 (S115), the U/I provision unit 117 generates an operation screen adapted for designating a download start timing and sends the screen to the client CL1, causing the client CL1 to display the operation screen (S120).

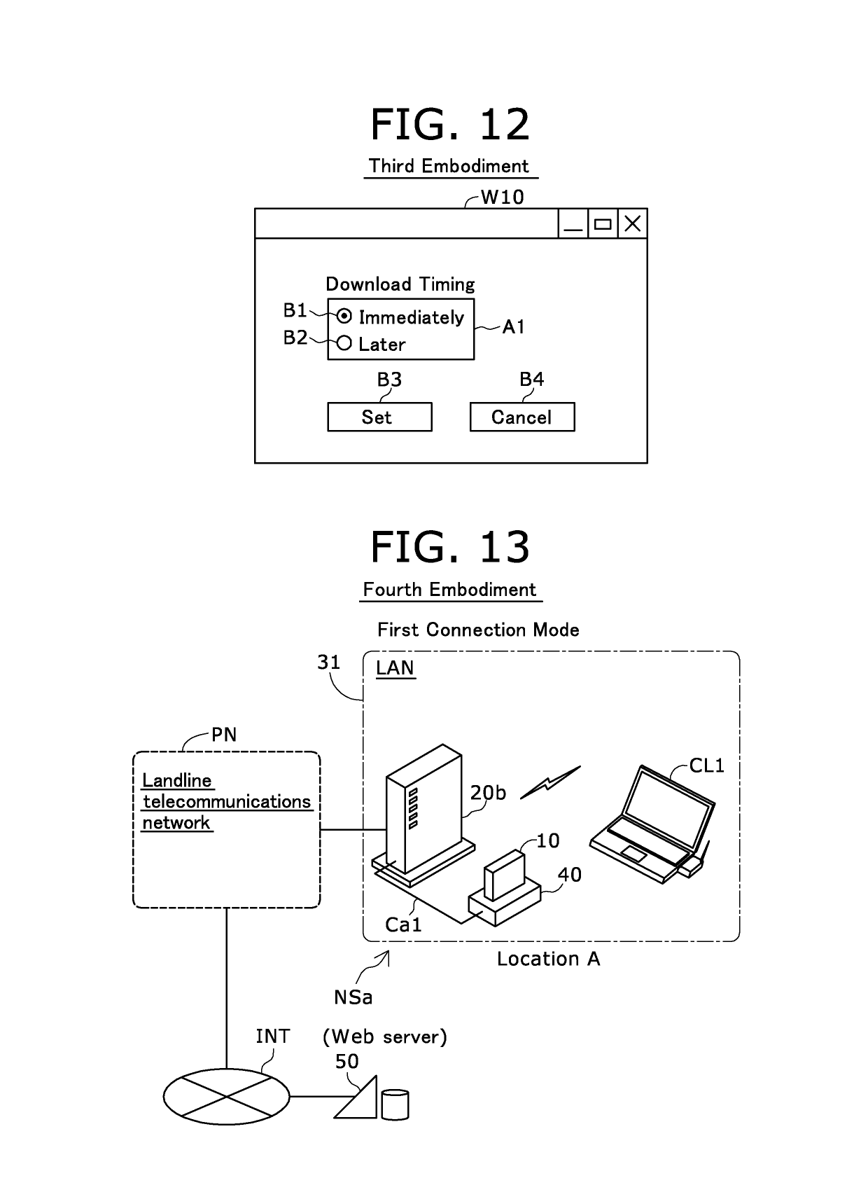

FIG. 12 is an explanatory diagram representing an operation screen displayed on a client in step S120. The operation screen W10 has a zone A1 for designating download start timing, a set button B3, and a cancel button B4. The zone A1 has two radio buttons B1 and B2 adapted for designating the download start timing as shown in FIG. 12. The radio button B1 is adapted for designating “immediately” as the download start timing. The radio button B2 is adapted for designating “later” as the download start timing. The start timing “immediately” means that downloading of a file is performed when the set button B3 is pressed. In contrast, the start timing “later” means that downloading of the file is performed when the mobile access point 10 and the home gateway 20 are physically connected to each other, constituting the first connection mode, likewise in the first embodiment. FIG. 12 exemplifies the case of the radio button B1 being pressed.

When a download start timing is selected with the set button B3 pressed in the operation screen W10 as shown in FIG. 12, information indicating the selected download start timing is sent to the mobile access point 10 from the client CL1.

As shown in FIG. 11, at the mobile access point 10, the download request accepting unit 115 stands by until receiving information indicating a download start timing (S125) after the above described step S120. When receiving the information, the download request accepting unit 115 determines whether the designated download start timing is “immediately” (S130).

If the designated download start timing is “later,” and not “immediately,” in the above described step S130, the processing is returned to the above described step S105. Therefore, the download process is accordingly performed likewise in the first embodiment, and the file is downloaded when the first connection mode is constituted in this case.

In the above described step S130, if the designated download start timing is “immediately” (“YES” for S130), the download-request transmitting unit 116 controls the mobile telecommunications control circuit 154 so as to send out signal to the mobile telecommunications network CN (S135).

The download-request transmitting unit 116 sends a file-download request to the server 50 as the destination in accordance with the designated URL stored in the designated URL storage unit 131 (S140). The download-request transmitting unit 116 controls the file-sharing control unit 118 so as to store a file in the memory card 136, the file downloaded from the server 50 (S145). Thus, if the download start timing designated by the user is “immediately,” the mobile access point 10 perform the transmission of a download request to the server 50 and the downloading of the file therefrom via the mobile telecommunications network CN in the third embodiment.

The wireless network system of the third embodiment configured as described above produces a similar effectiveness to that of the wireless network system NS of the first embodiment in the case in which the designated download start timing is not “immediately.” In addition, the wireless network system of the third embodiment is configured to display, on the client CL1, the operation screen W10 adapted for designating the download start timing and to download a file in accordance with the start timing designated (i.e., selected) on the operation screen W10, thereby allowing the user to manage the start timing of downloading the file. Therefore, for example, when the client CL1 is not engaged in other communications via the mobile telecommunications network CN, the time for obtaining the file can be shortened without influencing on the other communications. Further, for example, when a file of small size is downloaded, the downloading of the file via the mobile access point 10 will not cause a substantial reduction in the residual power of the battery 170. Therefore, the downloading of the file via the mobile access point 10 makes it possible to shorten the time for obtaining the file in such a case.

### D. Fourth Embodiment

FIG. 13 is a simplified explanatory diagram representing the configuration of a wireless network system of a fourth embodiment. The first connection mode of a wireless network system NSa of the fourth embodiment is shown in FIG. 13. The wireless network system NSa of the fourth embodiment is different from the wireless network system NS of the first embodiment shown in FIG. 1, where the former is configured to have a cradle 40 via which the mobile access point 10 is connected to a home gateway 20b. Otherwise, the configuration of the wireless network system NSa is the same as that of the wireless network system NS of the first embodiment. The cradle 40 is connected to the home gateway 20b by a network cable Cal. When physically connecting to the mobile access point 10 through contact, the cradle 40 supplies it with the power and mediates exchange of data between the mobile access point 10a and the home gateway 20b.

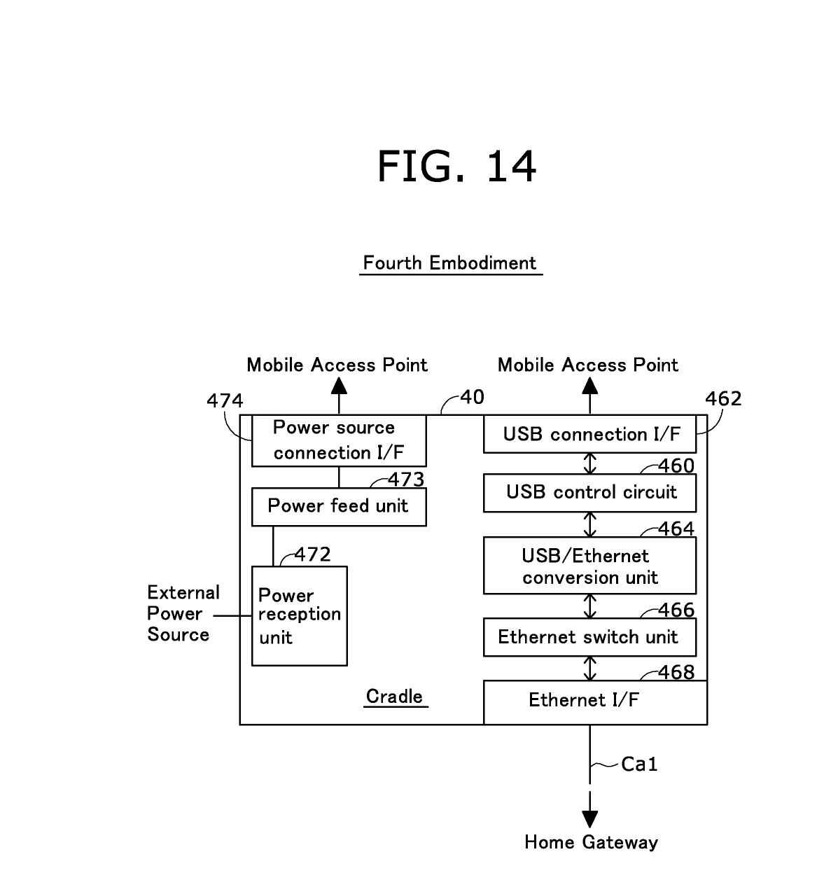

FIG. 14 is a block diagram illustrating configurational details of the cradle shown in FIG. 13. The cradle 40 includes a USB control circuit 460, a USB connection I/F 462, a USB/Ethernet conversion unit 464, an Ethernet switch unit 466, an Ethernet I/F 468, a power reception unit 472, a power feed unit 473, and a power source connection I/F 474.

The USB control circuit 460 has the same function as that of the USB control circuit 260 of the first embodiment shown in FIG. 4, and therefore the description is not provided herein. Likewise, the USB connection I/F 462, the USB/Ethernet conversion unit 464, the Ethernet switch unit 466, the power reception unit 472, the power feed unit 473, and the power source connection I/F 474 have respectively the same functions as those of the USB connection I/F 262, the USB/Ethernet conversion unit 264, the Ethernet switch unit 266, the power reception unit 272, the power feed unit 273, and the power source connection I/F 274 which are shown in FIG. 4, and therefore the descriptions are not provided herein.

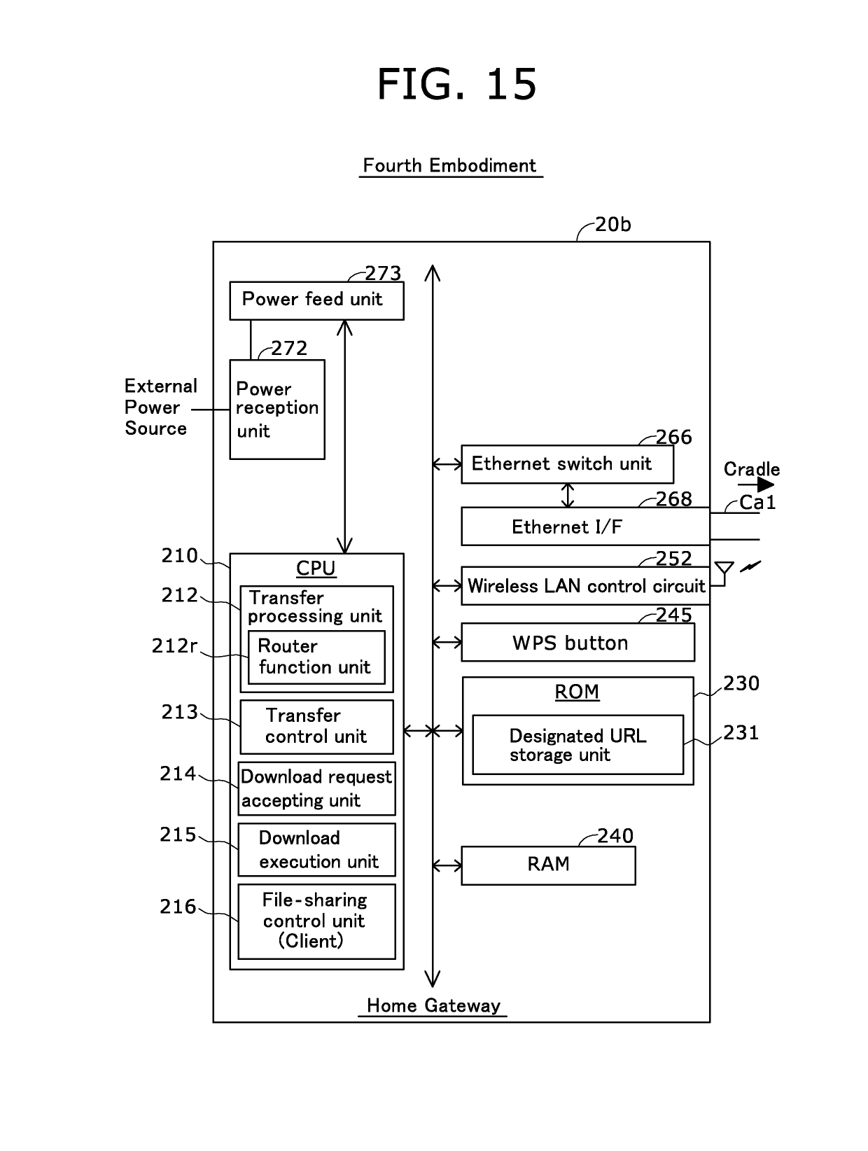

FIG. 15 is a block diagram illustrating configurational details of a home gateway of the fourth embodiment. A home gateway 20b of the fourth embodiment is different from the home gateway 20 of the first embodiment shown in FIG. 4, where the former is configured to include none of the USB control circuit 260, USB connection I/F 262, USB/Ethernet conversion unit 264, and power source connection I/F 274; otherwise the configuration of the home gateway 20b of the fourth embodiment is the same as that of the home gateway 20 of the first embodiment. That is, a part of the functional units of the home gateway 20 of the first embodiment is realized by the cradle 40 in the fourth embodiment.

The download request accepting process of the fourth embodiment is the same as the download request accepting process of the first embodiment. Meanwhile, the download process of the fourth embodiment is different from the download process of the first embodiment shown in FIG. 6, where the former is configured to cause the cradle 40 to relay exchange of information between the mobile access point 10 and the home gateway 20b; otherwise, the procedure is the same as that of the first embodiment.

The wireless network system NSa of the fourth embodiment configured as described above produces the same effectiveness as that of the wireless network system NS of the first embodiment. In addition, the fourth embodiment can realize the wireless network system NSa using a home gateway having no USB/Ethernet conversion functionality, because it is configured so that the cradle 40 carries out USB/Ethernet conversion.

### E. Embodiment Modifications

The present invention is in no way limited to the above described embodiments or modes thereof, and may rather be embodied in various modes within the spirit and scope of the invention, as put forth in the exemplary modes as follows.

### E1. Modification Example 1

The third embodiment is configured so that the file download start timing that can be designated on the operation screen W10 is “now” or “later”; the present invention is not limited to those start timings. An alternative configuration may allow the start timing to be designated as within a predetermined period, such as “within 10 minutes,” or after a predetermined period elapses, such as “after 10 minutes elapses.” In such a configuration, when “within a predetermined period” is selected, a download request will be sent to the server 50 via the mobile access point 10 at any given start timing within the predetermined period; or when “after a predetermined period elapses” is selected, the download request will be sent to the server 50 via the mobile access point 10 in a manner similar to the first embodiment when the first connection mode is constituted after the predetermined period has elapsed.

Further in the third embodiment, the user interface for allowing a file download start timing to be designated is the operation screen W10 displayed on the client CL1; the present invention is not limited as such. For example, a button or buttons adapted for designating a download start timing (e.g., a button for designating “immediately” and a button for designating “later”) may also be disposed in the operation screen displayed on the client CL1. That is, typically, any given user interface for allowing a file download start timing to be designated may be adopted for the wireless network system of the present invention.

### E2. Modification Example 2

The first, second and fourth embodiments are configured so that the file download start timing is when the first connection mode is constituted, with the mobile access point (10 or 10a) and the home gateway (20, 20a or 20b) physically contacted to each other. Meanwhile, the third embodiment is configured so that the aforementioned start timing is designated on the operation screen W10. The present invention, however, is not limited as such. It may also be configured to perform, in the download request accepting process: detecting reception signal strength of a signal output from a mobile telecommunications base station CB after a URL included in the download request is stored in the designated URL storage part 131 (i.e., after S115); and immediately carrying out the download via the mobile access point 10 if the reception signal strength is higher than predetermined strength, or carrying out the download when the first connection mode is constituted, as in the first embodiment, if the detected reception signal strength is lower than the predetermined strength.

### E3. Modification Example 3

Each of the above described embodiments is configured so that the mobile access point (10 or 10a) accepts the download request from the client CL1; it may also be configured so that the home gateway (20, 20a or 20b) accepts the download request, rather than the mobile access point (10 or 10a) does. For example, in the first connection mode, the wireless LAN communications function (i.e., the wireless LAN access point function) of the mobile access point (10 or 10a) is stopped, and therefore it is preferable to adopt a configuration in which the home gateway (20, 20a or 20) accepts a download request when the request is sent from the client CL1 in the first connection mode. In this configuration, the processing of the step S325 and thereafter are performed at the home gateway (20, 20a or 20), and thereby the downloaded file can be stored in the memory card 136 attached to the mobile access point (10 or 10a).

### E4. Modification Example 4

Each of the above described embodiments is configured so that the storage destination of a downloaded file is the memory card 136 attached to the mobile access point (10 or 10a); the present invention is not limited as such. Provided that, for example, the home gateway (20, 20a or 20) is configured to include a hard disk, the hard disk may be used for the storage destination of the downloaded file. Such a configuration allows a file to be stored when a download is succeeded even in a case in which the mobile access point (10 or 10a) is detached from the home gateway (20, 20a or 20) in a situation where the file cannot be downloaded due to a network failure, a server 50 failure, or the like, despite that the download request has been sent to the server 50 in the first connection mode. Further in this configuration, a file that has already been downloaded can be sent to the mobile access point (10 or 10a) when the first connection mode is once again constituted. In this case, the file sent to the mobile access point (10 or 10a) is preferably deleted from the hard disk. In an alternative configuration in which the home gateway (20, 20a or 20) is connected to an apparatus (e.g., a network-attached storage (NAS)) via a network, the apparatus having a storage device, the downloaded file can also be stored in the apparatus.

### E5. Modification Example 5

Each of the above described embodiments is configured so that the server 50 is connected to the home gateway (20, 20a or 20) via the Internet INT; however, it is possible to adopt a configuration in which the server 50 is connected to the home gateway (20, 20a or 20) via a wide-area Ethernet network (“Ethernet” is a registered trademark) provided by an electric power company and the like, or via an Internet protocol-virtual private network (IP-VPN), in lieu of via the Internet INT. Further, a configuration in which the home gateway (20, 20a or 20) is connected to a LAN that is different from the wireless LAN 31 may adopt a configuration including the home gateway (20, 20a or 20) that is connected to the server 50 via the aforementioned different LAN.

### E6. Modification Example 6

Each of the above described embodiments is configured so that the information used for specifying a file as a download target is an URL. However, any given information (e.g., a Uniform Resource Identifier (URI)), such as a Uniform Resource Name (URN), the information allowing specifying of a file may be adopted, instead of being limited to the URL.

### E7. Modification Example 7

Each of the above described embodiments is configured to use the mobile access point and the home gateway for the wireless network relay device for connecting the client CL1 to the Internet INT; the present invention is not limited as such. It is also possible to adopt any given apparatus (e.g., a mobile telephone terminal) having functionality of a wireless LAN access point, that of wireless communications with a mobile telecommunications base station of a mobile telecommunications network, and/or a router function, instead of the mobile access point (10 or 10a). It is further possible to adopt any given wireless network relay device, such as a Layer-3 switch, the device enabled to operate as a wireless LAN access point and a router, and connect to the landline communications network PN, instead of using the home gateway (20, 20a or 20).

### E8. Modification Example 8

Each of the above described embodiments is configured so that the communications band of the landline communications network PN is wider than that of the mobile telecommunications network CN; the present invention is not limited as such. It is also possible to adopt a configuration in which the communications band is the same in both the landline communications network PN and the mobile telecommunications network CN, or a configuration in which the communications band of the landline communications network PN is narrower than that of the mobile telecommunications network CN. Also in any of these configurations, a file is downloaded at the home gateway (20, 20a or 20), and thereby an increase in the processing load imposed on the mobile access point (10 or 10a) can be suppressed.

### E9. Modification Example 9

In each of the above described embodiments, the configurations of the mobile access point (10 or 10a) and home gateway (20, 20a or 20) are merely examples, and they may be modified in various shapes and forms. In each of the above described embodiments, for example, the wireless LAN control circuit (152 or 252) may adopt a wireless communications interface for wirelessly communicating in a general wireless LAN that will possibly be available in the future, in lieu of being limited to the wireless LAN in compliance with the IEEE802.11a/b/g. Further, the mobile telecommunications control circuit 154 may adopt a wireless communications interface for wirelessly communicating in a general wireless LAN that will possibly be available in the future, such as Long Term Evolution (LTE), a next-generation mobile WiMAX (IEEE802.16m), and a next-generation PHS (i.e., eXtended Global Platform (XGP)), in lieu of being limited to the mobile telecommunications in compliance with the 3G/HSPA.

Further, each of the above described embodiments is configured to use the USB for a connection interface for data exchange between the mobile access point and the home gateway; it is also possible to adopt any other given communications interface, instead of the USB. Furthermore, the present invention is applicable to general wireless communications in a predetermined wireless network, instead of being limited to the wireless LAN and the mobile telecommunications.

Further, each of the above described embodiments may alternatively be configured to replace a part of the constitution realized by hardware with software, or inversely, replace a part of the constitution realized by software with hardware. Furthermore, in a case where software is employed to realize a part or the entirety of the function of the present invention, the software (i.e., the computer program) may be provided in a form stored in a computer-readable recording medium. According to the present invention, the “computer-readable recording medium” includes not only a portable recording medium such as a flexible disk and CD-ROM but also an internal storage device incorporated in a computer in various shapes and forms such as various kinds of RAM and ROM, and an external storage device fixed in a computer in the form of, for example, a hard disk. That is, the “computer-readable recording medium” has a broad meaning that comprehends any given recording medium capable of storing data permanently, not temporarily.

### E10. Modification Example 10

The first embodiment described above is configured to attach the mobile access point 10 to the home gateway 20, connecting the former to the latter as shown in FIG. 1; the present invention is not limited as such. Any given configuration may also be adopted, provided that it is possible to connect them to each other. For example, the mobile access point 10 and the home gateway 20 may also be connected to each other utilizing a chosen communications cable, such as a USB cable.

### E11. Modification Example 11

The first embodiment described above is configured so that the connection monitor unit 114 of the CPU 110 automatically determines connection between the mobile access point 10 and the home gateway 20 (reference is made to S105 shown in FIG. 5); the present invention is not limited as such if the component is capable of determining the connection between the mobile access point 10 and the home gateway 20. An alternative configuration may also dispose a “connection complete” button on, for example, the mobile access point 10 and/or the home gateway 20 so as to determine that the mobile access point 10 is connected to the home gateway 20 when the “connection complete” button is pressed. Such a configuration is also applicable to the connection monitor unit 217 of the home gateway 20 of the second embodiment.

### E12. Modification Example 12

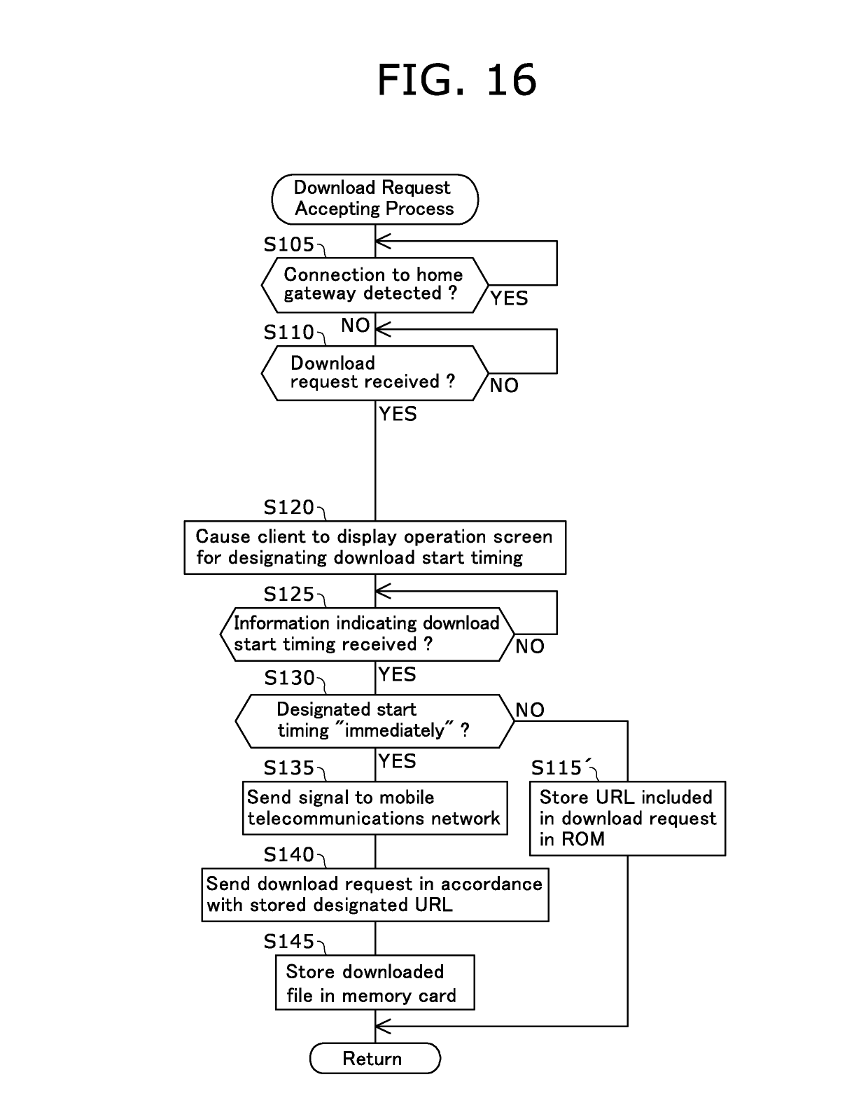

The third embodiment described above is configured so that when download requests are obtained, URLs included in the download requests are stored in the designated URL storage unit 131 of the ROM 130 of the mobile access point 10 (reference is made to S115 indicated in FIG. 11); however, the present embodiment may also be configured to select the URL to be stored in the ROM 130 on the basis of the download start timing. For example, it may be configured so that, when the download start timing relating to the file to be downloaded is not “immediately” (“NO” in S130 of FIG. 16), the URL is stored in the designated URL storage unit 131 of the ROM 13 (S115′ as indicated in FIG. 16). This configuration eliminates downloading of a file from the home gateway 20, the file that has already been downloaded at the mobile access point 10, making it possible to prevent a double download.

### E13. Modification Example 13

The third embodiment described above is configured so that, upon obtaining a download request, the mobile access point 10 sends the operation screen W10 adapted for designating a download start timing and obtains the download start timing via the operation screen W10 (reference is made to S120 shown in FIG. 11); the present invention is not limited as such; any given configuration may be adopted, provided that it is enabled to obtain the download start timing. For example, the present embodiment may be configured so that the operation screen W10 is displayed when a file to be downloaded is selected on the client so as to obtain the download start timing together with a download request. In this case, for example, a program for displaying the operation screen W10 is preferably pre-installed in the client.

### E14. Modification Example 14

The first embodiment described above is configured so that the mobile access point 10 that is a mobile wireless network relay device, has different interfaces, i.e., the power source connection I/F 174 and USB connection I/F 162, thereby realizing exchange of data with, reception of power from, and supply of the power to, the home gateway 20 that is a fixed wireless network relay device. Meanwhile, the mobile wireless network relay device is not limited to the one exemplified herein; if it is provided that it has a power reception unit adapted for receiving power supplied from the fixed wireless network relay device when the mobile wireless network relay device and the fixed wireless network relay device are connected to each other via a first connection unit. For example, the mobile wireless network relay device may have a USB connection interface of a power supply type for realizing an integrated data and power exchange property as the first connection unit. Such a configuration may also be applied to the fixed wireless network relay device.

This application is based on, and claims the benefit of priority from, prior Japanese Patent Application No. 2011-156285, filed on Jul. 15, 2011, the entire contents of which are incorporated herein by reference.

What is claimed is:

1. A wireless network system comprising:
a mobile wireless access point for relaying client accessing of a first communications network; and
a fixed wireless access point for relaying client accessing of a second communications network;
said mobile wireless access point including
a first connection unit for connecting to said fixed wireless access point and enabling communications between said fixed and mobile wireless access points,
a first download-request accepting unit for receiving from the client a download request requesting downloading of a file,
a download-request transmitting unit for transmitting, when said mobile wireless access point and said fixed wireless access point are connected to each other via said first connection unit, a received download request to said fixed wireless access point via said first connection unit,
a file storage unit for storing files, and
a file-storage control unit for receiving, via said first connection unit, a file transmitted from said fixed wireless access point, and storing the file in said file storage unit; and
said fixed wireless access point including
a second connection unit for connecting to said first connection unit of said mobile wireless access point and enabling communications between said mobile and fixed wireless access points,
a download-request receiving unit for receiving, when said mobile wireless access point and said fixed wireless access point are connected to each other via said second connection unit, a transmitted download request from said mobile wireless access point via said second connection unit,
a first file acquisition unit for downloading, based on a received download request, a file via said second communications network, and
a file transmitting unit for transmitting, when said mobile wireless access point and said fixed wireless access point are connected to each other via said second connection unit, the downloaded file to said mobile wireless access point via said second connection unit.

2. The wireless network system according to claim 1, wherein said first file acquisition unit downloads files via a second communications network of wider communications band than that of the first communications network.

3. The wireless network system according to claim 1, wherein:
said first download-request accepting unit receives a download request including file-specifying information for specifying a file to be downloaded;
said mobile wireless access point further includes
a file-specifying information storage unit for storing the file-specifying information, and
a file-specifying information storage control unit for controlling storing, into said file-specifying information storage unit, of the file-specifying information that the download request contains; and
said download-request transmitting unit transmits, to said fixed wireless access point via said first connection unit, the download request including the file-specifying information stored in said file-specifying information storage unit.

4. The wireless network system according to claim 3, wherein:
said mobile wireless access point further includes
a download start timing acquisition unit for acquiring a download start timing relating to a file to be downloaded, and
a second file acquisition unit for downloading the file based on the received download request; and
said download-request transmitting unit, if the start timing is within a predetermined period, transmits the download request to said second file acquisition unit, and if the start timing is not within the predetermined period, transmits the download request to said fixed wireless access point when said mobile wireless access point and said fixed wireless access point are connected to each other via said first connection unit.

5. The wireless network system according to claim 4, wherein if the start timing is within a predetermined period said file-specifying information storage control unit does not store, into said file-specifying information storage unit, file-specifying information of the file relating to the start timing.

6. The wireless network system according to claim 4, wherein said mobile wireless access point further includes a download start timing specification user-interface provision unit for providing the client with a download start timing specification user-interface upon accepting a download request from the client, the user interface for specifying start timing of file downloading.

7. The wireless network system according to claim 1, wherein:
said fixed wireless access point further includes a second download request accepting unit for accepting a download request from the client;
said first download request accepting unit stops accepting download requests if said mobile wireless access point and said fixed wireless access point are connected to each other via said second connection unit;
said second download request accepting unit accepts download requests if said mobile wireless access point and said fixed wireless access point are connected to each other via said second connection unit; and
in response to a download request accepted by said second download request accepting unit, said first file acquisition unit downloads the file.

8. The wireless network system according to claim 1, wherein:
said mobile wireless access point further includes a connection determination unit for determining whether interconnection between said mobile wireless access point and said fixed wireless access point via said first connection unit is established; and
the download-request transmitting unit transmits download requests to said fixed wireless access point via said first connection unit, if said connection determination unit determines that the interconnection is established.

9. The wireless network system according to claim 1, wherein:
said fixed wireless access point further includes
a connection determination unit for determining whether interconnection between said mobile wireless access point and said fixed wireless access point via said second connection unit is established, and
a transmission request transmitting unit for transmitting, if said connection determination unit determines that the interconnection is established, to said mobile wireless access point via said second connection unit a transmission request requesting transmission of the received download request;
said mobile wireless access point further includes transmission request reception means for receiving the transmission request; and
said download-request transmitting unit transmits, upon receiving the transmission request and determining that said mobile wireless access point and said fixed wireless access point are connected to each other via said first connection unit, the download request to said fixed wireless access point via said first connection unit.

10. The wireless network system according to claim 1, wherein the mobile wireless access point further comprises a storage medium including said file storage unit and being freely attachable to and detachable from said mobile wireless access point.

11. The wireless network system according to claim 1, wherein:
said mobile wireless access point further includes
a battery,
a power reception unit for receiving power supplied from said fixed wireless access point when said mobile wireless access point and said fixed wireless access point are connected to each other via said first connection unit, and
a first power feed unit for supplying the battery with power supplied via said power reception unit; and
said fixed wireless access point further includes a second power feed unit for supplying said mobile wireless access point with power when said mobile wireless access point and said fixed wireless access point are connected to each other via said second connection unit.

12. A mobile wireless access point for relaying client accessing of a first communications network, and connectable to a fixed wireless access point, the fixed access point for relaying client accessing of a second communications network, the mobile wireless access point comprising:
a connection unit for connecting to the fixed wireless access point and enabling communications between the fixed and mobile access points;
a download-request accepting unit for receiving from the client a download request requesting downloading of a file;
a download-request transmitting unit for transmitting, when the mobile wireless access point and the fixed wireless access point are connected to each other via said connection unit, a received download request to the fixed wireless access point via said connection unit;
a file storage unit for storing files; and
a file-storage control unit for receiving, via said connection unit, a file transmitted from the fixed wireless access point, and storing the file in said file storage unit.

13. A fixed wireless access point for relaying client accessing of a second communications network, and connectable to a mobile wireless access point, the mobile access point for relaying client accessing of a first communications network, the fixed wireless access point comprising:
a connection unit for connecting to the mobile wireless access point and enabling communications between the mobile and fixed access points;
a download-request receiving unit for receiving, when the mobile wireless access point and the fixed wireless access point are connected to each other via the connection unit, a transmitted file-download request from the mobile wireless access point via said connection unit;
a file acquisition unit for downloading, based on a received download request, a file via the second communications network; and
a file transmitting unit for transmitting, when the mobile wireless access point and the fixed wireless access point are connected to each other via said connection unit, the downloaded file to the mobile wireless access point via said connection unit.

14. A method of controlling a wireless network system constituted by a mobile wireless access point for relaying client accessing of a first communications network, and a fixed wireless access point for relaying client accessing of a second communications network, the wireless network system control method comprising:
(a) a step, in the mobile wireless access point, of receiving from the client a download request requesting downloading of a file;
(b) a step, in the mobile wireless access point, of transmitting, when the mobile wireless access point and the fixed wireless access point are connected to each other via respective connection units, a received download request to the fixed wireless access point via the respective connection units;
(c) a step, in the fixed wireless access point, of receiving, when the mobile wireless access point and the fixed wireless access point are connected to each other via the respective connection units, a transmitted download request from the mobile wireless access point via the respective connection units;
(d) a step, in the fixed wireless access point, of downloading, based on a received download request, a file via the second communications network;
(e) a step, in the fixed wireless access point, of transmitting, when the mobile wireless access point and the fixed wireless access point are connected to each other via the respective connection units, the downloaded file to the mobile wireless access point via the respective connection units; and
(f) a step, in the mobile wireless access point, of receiving, via the respective connection units, a file transmitted from the fixed wireless access point, and storing the file in a file storage unit of the mobile wireless access point.

15. A computer-readable non-volatile recording medium on which is recorded a program for controlling a mobile wireless access point, the mobile access point for relaying client accessing of a first communications network and connectable to a fixed wireless access point, the fixed access point for relaying client accessing of a second communications network, the program for causing the mobile access point to realize:
a function of receiving from the client a download request requesting downloading of a file;
a function of transmitting, when the mobile wireless access point and the fixed wireless access point are connected to each other via respective connection units, a received download request to the fixed access point via the respective connection units; and
a function of receiving, via the respective connection units, a file transmitted from the fixed wireless access point, and storing the file in a file storage unit of the mobile wireless access point.

16. A computer-readable non-volatile recording medium on which is recorded a program for controlling a fixed wireless access point, the fixed access point for relaying client accessing of a second communications network and connectable to a mobile wireless access point, the mobile access point for relaying client accessing of a first communications network, the program for causing the fixed wireless access point to realize:
a function of receiving, when the mobile wireless access point and the fixed wireless access point are connected to each other via respective connection units, a transmitted download request from the mobile wireless access point via the respective connection units;
a function of downloading, based on a received download request, a file via the second communications network; and
a function of transmitting, when the mobile wireless access point and the fixed wireless access point are connected to each other via the respective connection units, the downloaded file to the mobile wireless access point via the respective connection units.

17. A wireless network system constituted by at least one mobile access point and one gateway each including respective connection interfaces whereby the mobile access point and gateway are physically interconnectable for intercommunication between them;
said mobile access point comprising
a gateway-connection monitor means,
a client download-request accepting unit for accepting file-download requests sent wirelessly from a client,
a download-request conditional transmission means for sending, via said mobile access point's connection interface, a gateway probe packet if said gateway-connection monitor means determines that said mobile access point and a gateway are interconnected, and for transmitting to the gateway a file-download request accepted by said client download-request accepting unit, conditional upon receiving from the gateway a response packet to the gateway probe packet, and
file storage/control means for receiving, into storage, from a response-packet-sending gateway a file downloaded by the gateway in response to a file-download request conditionally transmitted to the gateway from said download-request conditional transmission means; and
said gateway comprising
a download-request receiving means for monitoring, via said gateway's connection interface, for reception of a gateway probe packet from a mobile access point, and in response to a received gateway probe packet, sending via said gateway's connection interface a response packet destination-directed by information in the probe packet, and for receiving via said gateway's connection interface a file-download request as transmitted from the probe-packet-sending mobile access point,
a file acquisition unit for downloading, based on the received file-download request, the file via the gateway's communications network, and
a file transmitting unit for transmitting the downloaded file to the probe-packet-sending mobile access point via said gateway's connection interface.
